(19) United States
(12) Patent Application Publication
(10) Pub. No.: US 2026/0056323 A1
(43) Pub. Date: Feb. 26, 2026

(54) ASSIST SYSTEM

(71) Applicant: Kubota Corporation, Osaka (JP)

(72) Inventor: Shotaro KAWAHATA, Fremont, CA (US)

(21) Appl. No.: 19/210,041

(22) Filed: May 16, 2025

Related U.S. Application Data
(60) Provisional application No. 63/686,938, filed on Aug. 26, 2024.

(51) Int. Cl. G01S 17/931; G01C 21/34; G01C 21/36

(52) U.S. Cl. CPC G01S 17/931; G01C 21/3407; G01C 21/3697

(57) ABSTRACT

An assist system includes a first mobile body including a detector to detect objects in a surrounding area of the first mobile body, and a first communicator configured or programmed to transmit object information about an object detected by the sensor and detection time information indicating a detection time at which the object is detected, and a server including a calculator configured or programmed to calculate, based on the object information and the detection time information from the first mobile body, an after-time outer end position of the object in a time-of-use during which the object information is to be used, and a second communicator configured or programmed to transmit the after-time outer end position to the first mobile body or to a second mobile body.

### CROSS-REFERENCE TO RELATED APPLICATIONS

This application claims the benefit of priority to U.S. Provisional Patent Application No. 63/686,938 filed on Aug. 26, 2024. The entire contents of this application is hereby incorporated herein by reference.

### BACKGROUND OF THE INVENTION

### 1. Field of the Invention

The present invention relates to assist systems to assist mobile bodies which travel based on object information about detected objects in surrounding areas of the mobile bodies.

### 2. Description of the Related Art

An automatic travel system disclosed in Japanese Unexamined Patent Application Publication No. 2022-146457 includes a travel machine body including a working device, a range sensor to measure the distances to objects in the surrounding area of the travel machine body, a machine body position calculator to use a Simultaneous Localization and Mapping (SLAM) algorithm to process measured distance signals from the range sensor to calculate the position of the machine body, and an automatic-travel controller to cause the travel machine body to automatically travel based on the position of the machine body. Specifically, the machine body position calculator creates an environment map which includes point cloud data of the surrounding environment acquired at the range sensor by processing using the SLAM algorithm, and calculates the position of the machine body on the environment map. Since the environment map indicates objects in the surrounding area of the travel vehicle body, the environment map can be regarded as object information.

### SUMMARY OF THE INVENTION

In the automatic travel system of Japanese Unexamined Patent Application Publication No. 2022-146457, an environment map is created each time the machine body travels autonomously, because the environment map (object information) may change over time. Therefore, for example, the environment map (object information) created for the previous autonomous travel cannot be used as-is for the current autonomous travel which is different in time from the previous travel.

Example embodiments of the present invention provide assist systems each of which make it possible to make effective use of object information in a time period different in time from the detection time of the object information.

An assist system according to an example embodiment of the present invention includes a first mobile body including a detector to detect objects in a surrounding area of the first mobile body, and a first communicator configured or programmed to transmit object information about an object detected by the detector and detection time information indicating a detection time at which the object is detected, and a server including a calculator configured or programmed to calculate, based on the object information and the detection time information from the first mobile body, an after-time outer end position of the object in a time-of-use during which the object information is to be used, by measuring a time from the detection time, and a second communicator configured or programmed to transmit the after-time outer end position to the first mobile body or to a second mobile body.

The calculator may be configured or programmed to calculate the after-time outer end position by changing an outer end position of the object at the detection time, based on elapsed time information about a time from the detection time to the time-of-use.

The calculator may be configured or programmed to consult a preset table indicating a relationship between the detection time, the time-of-use, and the after-time outer end position to calculate the after-time outer end position.

The server may include an estimator configured or programmed to identify whether the object is a plant and, in a case that the object is a plant, estimate a type and a growth state of the plant. The calculator may be configured or programmed to calculate the after-time outer end position by changing an outer end position of the object at the detection time based on a current growth state of the plant.

The calculator may be configured or programmed to consult a preset growth table indicating a relationship between the detection time, the current growth state, and the after-time outer end position to calculate the after-time outer end position.

The estimator may be configured or programmed to identify whether the object is a fruit tree. The calculator may be configured or programmed to, in a case that the object is a fruit tree, calculate the after-time outer end position of a tree row that is a line connecting, in a predetermined direction, a plurality of the outer end positions of a plurality of the fruit trees arranged at one or more intervals in the predetermined direction.

The assist system may further include an estimator configured or programmed to, in a case that the object is a crop, identify a type of the crop. The server may include a plurality of the tables corresponding to respective types of a plurality of the crops, and may be configured or programmed to consult one of the plurality of tables that corresponds to the type of the crop to calculate the after-time outer end position.

The estimator may be configured or programmed to, in a case that the object is a crop, identify a type of the crop. The server may include a plurality of the growth tables corresponding to respective types of a plurality of the crops, and may be configured or programmed to consult one of the plurality of growth tables that corresponds to the type of the crop to calculate the after-time outer end position.

The second mobile body may include a position detector to detect a position thereof but not include the detector. The server may include a route generator configured or programmed to generate a route to be traveled by the second mobile body based on acquired position information of the second mobile body and based on the after-time outer end position calculated by the calculator. The second communicator may be configured or programmed to transmit the route to be traveled by the second mobile body to the second mobile body.

The calculator may be configured or programmed to define an off-limits area having a predetermined dimension extending from an outer end position of the object outward based on the object information and the detection time information, and use an outer end position of the off-limits area as the after-time outer end position. The second communicator may be configured or programmed to transmit the outer end position of the object and the off-limits area to the first mobile body or to the second mobile body.

The calculator may be configured or programmed to calculate the after-time outer end position by changing the predetermined dimension of the off-limits area based on elapsed time information about a time from the detection time to the time-of-use.

The server may include an estimator configured or programmed to identify whether the object is a plant and, in a case that the object is a plant, estimate a type and a growth state of the plant. The calculator may be configured or programmed to calculate the after-time outer end position by changing the predetermined dimension of the off-limits area based on the detection time and a current growth state of the plant.

The second mobile body may include a position detector to detect a position thereof but not include the detector. The server may include a route generator configured or programmed to generate a route to be traveled by the second mobile body based on acquired position information of the second mobile body and based on the outer end position of the object calculated by the calculator and the off-limits area. The second communicator may be configured or programmed to transmit the route to be traveled by the second mobile body to the second mobile body.

The calculator may be configured or programmed to define a fixed off-limits area having a predetermined dimension extending from the outer end position of the object outward, and use an outer end position of the off-limits area as the after-time outer end position. The second communicator may be configured or programmed to transmit the outer end position of the object and the off-limits area to the first mobile body or to the second mobile body.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a block diagram showing an assist system.

FIG. 2 is a schematic side view showing a working machine.

FIG. 3 is a schematic plan view showing a working machine.

FIG. 4 is a perspective view of a position changer as viewed from the rear.

FIG. 5A illustrates an example of sensed areas of sensors provided on a working machine.

FIG. 5B illustrates a planned travel route L.

FIG. 6 illustrates an assist system in which object information detected by a first working machine is made use of by a second working machine.

FIG. 7 illustrates summer in which the space between tree rows is minimum and winter in which the space between tree rows is maximum.

FIG. 8 illustrates an example of data flow within an assist system according to an example embodiment of the present invention.

FIG. 9A illustrates after-time outer end positions obtained by changing outer end positions depending on the season, in a first example embodiment of the present invention.

FIG. 9B illustrates after-time outer end positions obtained by expanding or reducing off-limits areas depending on the season, in a second example embodiment of the present invention.

FIG. 9C illustrates after-time outer end positions of the first, fourth and seventh months in the case of using data acquired in winter, in the first example embodiment of the present invention.

FIG. 9D illustrates after-time outer end positions of the first, fourth and seventh months in the case of using data acquired in summer, in the first example embodiment of the present invention.

FIG. 9E illustrates after-time outer end positions of January, April and July in the case of using data acquired in winter, in the first example embodiment of the present invention.

FIG. 9F illustrates after-time outer end positions of January, April and July in the case of using data acquired in summer, in the first example embodiment of the present invention.

FIG. 9G illustrates after-time outer end positions of the first, fourth and seventh months in the case of using data acquired in winter, in the second example embodiment of the preset invention.

FIG. 9H illustrates after-time outer end positions of the first, fourth and seventh months in the case of using data acquired in summer, in the second example embodiment of the present invention.

FIG. 9I illustrates after-time outer end positions of January, April and July in the case of using data acquired in winter, in the second example embodiment of the present invention.

FIG. 9J illustrates after-time outer end positions of January, April and July in the case of using data acquired in summer, in the second example embodiment of the present invention.

FIG. 10A is a flowchart showing a process performed in an assist system of a first pattern in the first example embodiment of the present invention.

FIG. 10B is a flowchart showing a process performed in an assist system of a first pattern in the second example embodiment of the present invention.

FIG. 11A is a flowchart showing a calculation process performed by a server shown in FIG. 10A.

FIG. 11B is a flowchart showing a calculation process performed by a server shown in FIG. 10B.

FIG. 12 is a flowchart showing a process performed in an assist system of a second pattern in the first and second example embodiments of the present invention.

FIG. 13A is a flowchart showing a calculation process performed by a server shown in FIG. 12 in the first example embodiment of the present invention.

FIG. 13B is a flowchart showing a calculation process performed by a server shown in FIG. 12 in the second example embodiment of the present invention.

FIG. 14 illustrates an example of a table.

FIG. 15 illustrates an example of a table.

FIG. 16 illustrates an example of a growth table.

FIG. 17 illustrates an example of a growth table for the Southern Hemisphere.

FIG. 18A illustrates examples of tables that correspond to types of crops.

FIG. 18B illustrates examples of growth tables that correspond to types of crops.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

The following discusses example embodiments of the present invention with reference to the drawings.

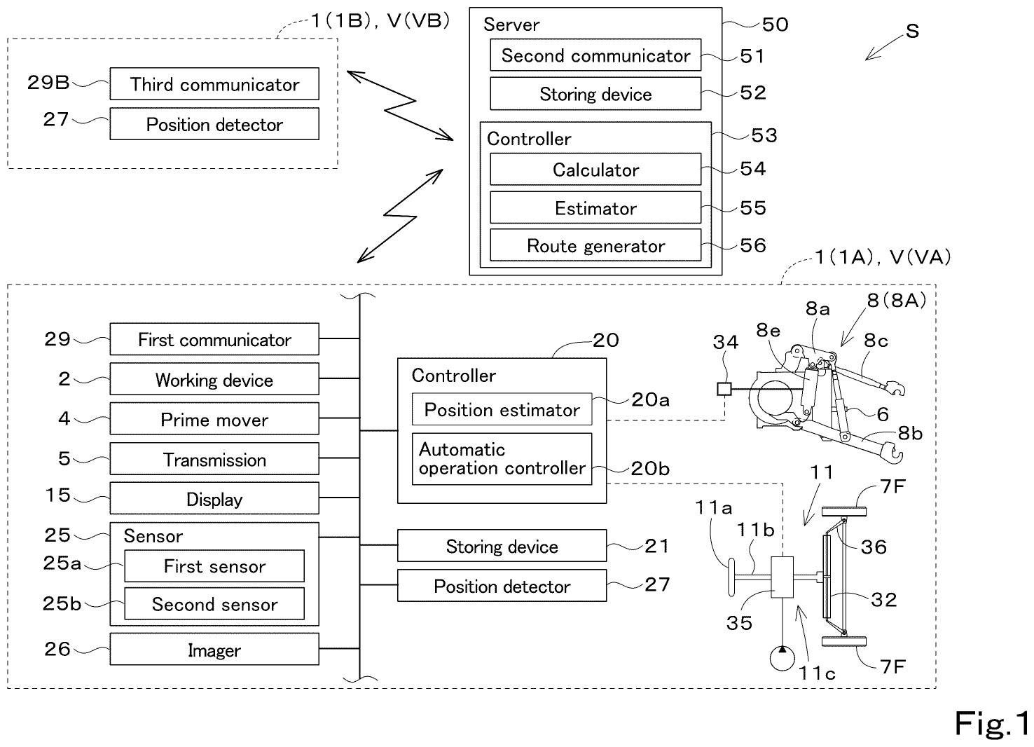

FIG. 1 is a block diagram showing an assist system S according to the present example embodiment. The assist system S is, for example, a system (apparatus) to assist a mobile body V in traveling within an agricultural field H1 or the like. The agricultural field H1 can be a vineyard, an orchard, a vegetable garden or the like. In the present example embodiment, the mobile body V is, for example, a working machine 1. However, the mobile body V may be a working vehicle, a drone (unmanned aircraft) such as a multicopter, a rover, or the like.

For example, the assist system S includes a first mobile body VA, a server 50 and a second mobile body VB. The first mobile body VA is a mobile body V to input information into the server 50 (mobile body V on the input side of the server 50), and is a first working machine 1A including a detector (for example, a sensor 25) to detect objects in the surrounding area of the first mobile body VA. The second mobile body VB is a mobile body V to receive information from the server 50 (that is, a mobile body V on the output side of the server 50), and is a second working machine 1B which does not include a detector (for example, a sensor 25). However, the second mobile body VB may be a first working machine 1A. In the case where the second mobile body VB is a first working machine 1A, the assist system S includes the first mobile bodies VA and the server 50.

First, the working machine 1 (particularly the first working machine 1A) will be discussed. The working machine 1 is a vehicle to perform work while traveling and, in the present example embodiment, is a tractor including a travel vehicle body 3 (machine body) to which a working device 2 (implement) is attachable. Note that the working machine 1 need only be a vehicle to perform work while traveling, and is not limited to a tractor. For example, the working machine 1 may be an agricultural machine such as a combine or a rice transplanter, or a construction machine such as a compact track loader or a backhoe.

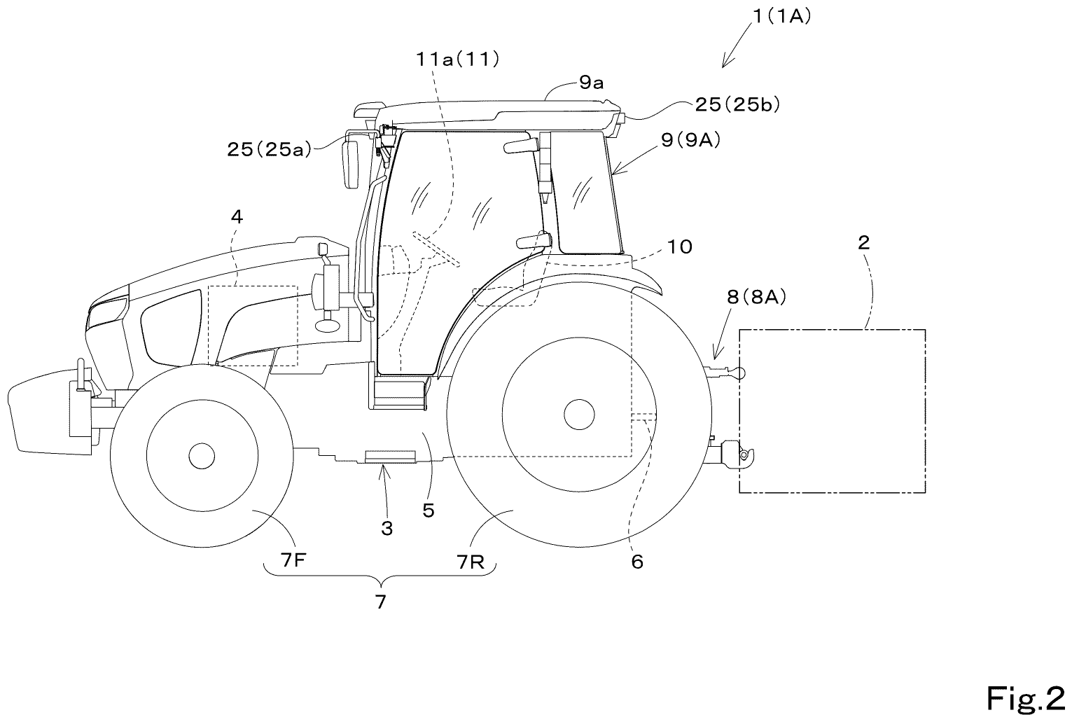

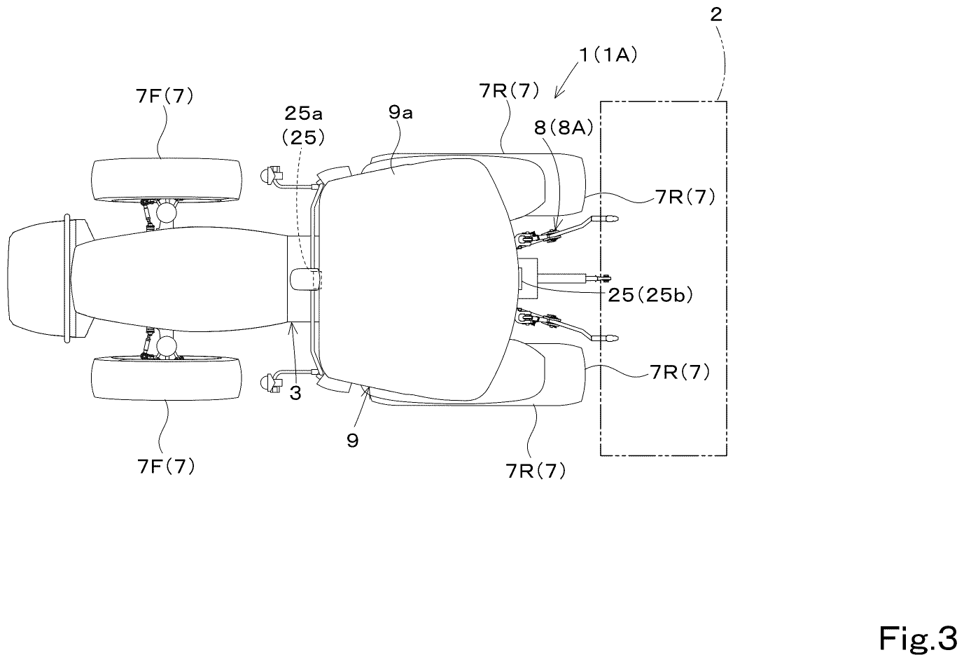

FIG. 2 is a schematic side view showing the working machine 1. FIG. 3 is a schematic plan view showing the working machine 1. In the description of the present example embodiment, the direction in which the user faces when seated on a seat 10 of the working machine 1 (left side of FIGS. 2 and 3) is referred to as front, and the opposite direction (right side of FIGS. 2 and 3) is referred to as rear. The left side of the user (near side of FIG. 2, lower side of FIG. 3) is referred to as left, and the right side of the user (far side of FIG. 2, upper side of FIG. 3) is referred to as right. The horizontal direction perpendicular to the front-rear direction is referred to as a width direction.

As shown in FIGS. 2 and 3, the working machine 1 includes a travel vehicle body 3 with a traveling device 7, a prime mover 4, and a transmission 5. The traveling device 7 imparts a driving force to the travel vehicle body 3 by being driven. The traveling device 7 is a wheeled traveling device 7 with front wheels 7F and rear wheels 7R which are tires. A pair of the front wheels 7F are arranged with a space therebetween in the width direction, and a pair of the rear wheels 7R are arranged with a space therebetween in the width direction. As another example, a traveling device 7 in which the front wheels 7F and/or the rear wheels 7R are crawlers may be used. The travel vehicle body 3 is driven by the traveling device 7 to travel frontward and rearward.

A front portion of the travel vehicle body 3 includes the prime mover 4. The prime mover 4 includes, for example, a diesel engine. As another example, the prime mover 4 may include another internal combustion engine such as a gasoline engine, an electric motor, and/or the like.

The transmission 5 is operable to, by switching speed stages, speed-change the power outputted by the prime mover 4 to change the driving force of the traveling device 7, as well as changing the state of the traveling device 7 (switching the direction of travel of the traveling device 7 to forward or rearward). The transmission 5 transmits power from the prime mover 4 to a PTO shaft 6. The PTO shaft 6 is an output shaft to drive the working device 2 by being connected to the working device 2.

On an upper portion of the travel vehicle body 3, a protection structure 9 is provided to protect the seat 10. The protection structure 9 is, for example, a cabin 9A surrounding the seat 10. The seat 10 is provided inside the cabin 9A. Note that the protection structure 9 is not limited to a cabin 9A, and may be a canopy, or a roll-over protective structure (ROPS) provided upright behind the seat 10.

The working device 2 is attached to the travel vehicle body 3. With regard to the tractor of the present example embodiment, the working device 2 is detachably attached to the travel vehicle body 3. Specifically, at a front portion and/or a rear portion of the travel vehicle body 3, a linkage 8 is provided to attach and detach the working device 2 thereto and therefrom. In the example shown in FIGS. 2 and 3, the linkage 8 is provided at the rear portion of the travel vehicle body 3. Thus, when the working device 2 is connected to the linkage 8 and the traveling device 7 is driven, the working machine 1 can tow the connected working device 2.

FIGS. 2 and 3 illustrate the linkage 8 which is a position changer 8A including a three-point linkage. The position changer 8A includes a lifter to change the relative positions of the travel vehicle body 3 and the working device 2 by raising or lowering the working device 2 relative to the travel vehicle body 3. The following describes in detail the position changer 8A including a three-point linkage.

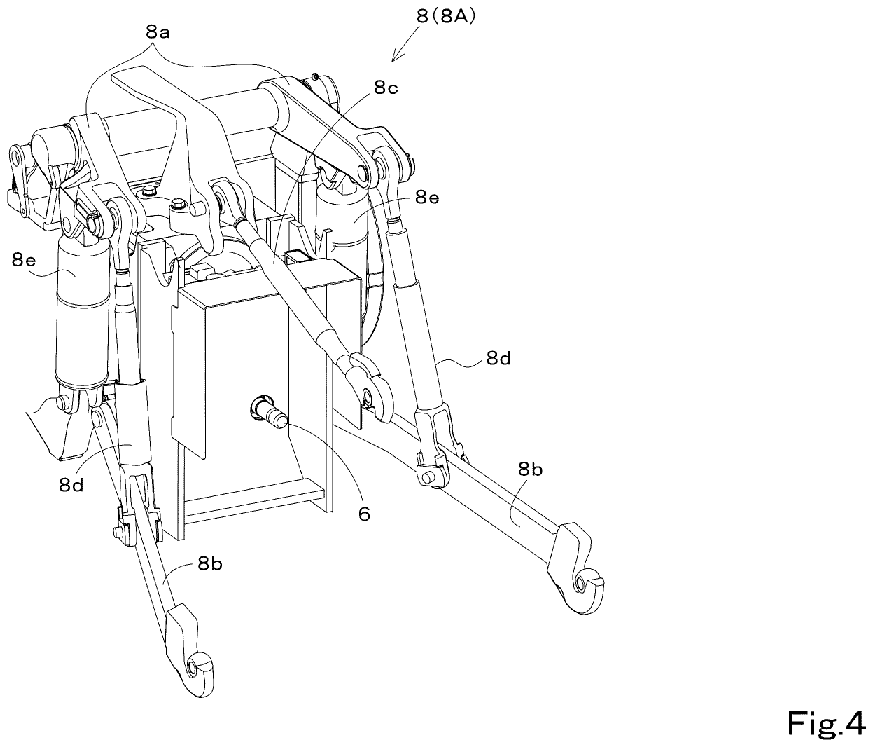

FIG. 4 is a perspective view of the position changer 8A as viewed from the rear. The position changer 8A includes lift arm(s) 8a, lower link(s) 8b, a top link 8c, lift rod(s) 8d, and lift cylinder(s) 8e.

Front ends of the lift arms 8a are connected to an upper rear portion of a case (transmission case) to house the transmission 5 such that the lift arms 8a are swingable upward and downward. The lift arms 8a are swung (raised or lowered) by being driven by the lift cylinders 8e. The lift cylinders 8e each include a hydraulic cylinder. As shown in FIG. 1, the lift cylinders 8e are connected to a hydraulic pump via a control valve 34. The control valve 34 is a solenoid valve or the like to cause the lift cylinders 8e to extend and retract.

Front ends of the lower links 8b are supported by a lower rear portion of the transmission 5 such that the lower links 8b are swingable upward and downward. A front end of the top link 8c is supported by a rear portion of the transmission 5 at a position higher than the lower links 8b such that the top link 8c is swingable upward and downward. The lift rods 8d connect the lift arms 8a and the lower links 8b. Rear portions of the lower links 8b and a rear portions of the top link 8c each have a hook shape.

When the lift cylinders 8e are driven (extend or retract), the lift arms 8a are raised or lowered, and the lower links 8b connected to the lift arms 8a via the lift rods 8d are also raised or lowered. With this, the working device 2 swings upward or downward (is raised or lowered) about a front portion of the lower links 8b.

Note that, in the above-described example, the linkage 8 is the position changer 8A including a three-point linkage. However, the linkage 8 need only be capable of connecting at least the working device 2 to the travel vehicle body 3. For example, the linkage 8 may include a swinging drawbar or the like to connect the working device 2 and the travel vehicle body 3 but not change the relative positions of the working device 2 and the travel vehicle body 3.

The working device 2 is operable to perform work on a work site H (for example, an agricultural field H1) or on a target object in the work site H (for example, crop(s) or the like planted in the agricultural field H1). The working device 2 includes a cultivator to perform cultivation work, a ridger to perform ridging, a trencher to form trenches, a harvester to harvest crops, a mower to mow grass or the like, a tedder to ted grass or the like, a rake to rake grass or the like, a baler to bale grass or the like, a fertilizer spreader to spread fertilizer, an agricultural chemical spreader to spread agricultural chemicals, a separator to separate crops, or the like. In the present example embodiment, the working device 2 includes, for example, a fertilizer spreader or an agricultural chemical spreader.

Note that, although the working machine 1 is a tractor and the working device 2 is connected to the linkage 8 in the above-described example, the working device 2 is not limited to an implement connected to the travel vehicle body 3 by the linkage 8. For example, the working device 2 may be a front loader to be attached to a front portion of the travel vehicle body 3.

The working device 2 need only be provided on the working machine 1 and perform work at the work site H, and does not need to be a device that is attachable and detachable to and from the travel vehicle body 3 such as an implement. For example, in the case where the working machine 1 is a combine, the working device 2 includes a mower to mow grass or the like. In the case where the working machine 1 is a rice transplanter, the working device 2 includes a planter to plant seedlings. In the case where the working machine 1 is a backhoe or a compact track loader, the working device 2 can be, for example, an attachment attached to the position changer 8A (arm(s), boom(s) and/or the like).

As shown in FIG. 1, the working machine 1 includes a steering system 11. The steering system 11 includes a handle 11a (steering wheel), a steering shaft 11b (rotation shaft) to rotate as the handle 11a rotates, and an assist mechanism 11c (power steering mechanism) to assist in the rotation of the handle 11a.

The assist mechanism 11c includes a control valve 35 and a steering cylinder 32. The control valve 35 is, for example, a three-position switching valve switchable by movement of a spool or the like. The control valve 35 is also switchable by rotation of the steering shaft 11b. The steering cylinder 32 is connected to arms 36 (knuckle arms) to change the orientation of the front wheels 7F. Thus, when the handle 11a is rotated, the switching position and the opening of the control valve 35 are changed according to the rotation of the handle 11a, the steering cylinder 32 extends or retracts to the left or to the right according to the switching position and the opening of the control valve 35, and the steering direction of the front wheel 7F is changed.

Note that the above-described steering system 11 is an example and is not limited to the above-described configuration. For example, in the case where the traveling device 7 is operable to change the steering angle by causing a difference between a driving force at one of the opposite sides in the width direction and a driving force at the other of the opposite sides in the width direction, the traveling device 7 may function also as the steering system 11.

As shown in FIG. 1, the working machine 1 includes a controller 20 and a storing device (memory and/or storage) 21. The controller 20 includes one or more processors. The controller 20 is configured or programmed to control the working machine 1, and perform various controls relating to the working machine 1. The controller 20 is connected in a communicable manner to apparatuses and devices in or on the working machine 1 via an in-vehicle network such as CAN, ISOBUS, LIN and/or FlexRay. For example, the controller 20 is configured or programmed to perform a control process (operation) to control the working device 2, the prime mover 4, the transmission 5, the position changer 8A, the steering system 11, and the like based on signals (operation signals) inputted from manual operator(s).

The controller 20 includes one or more memories, analog circuits, digital circuits and/or the like. One or more memories contain (store) software program(s) executed by one or more processors, and various types of data. The controller 20 is configured or programmed to, via one or more processors, read software program(s) from one or more memories and perform various processes based on the software program(s). Note that the controller 20 may be configured or programmed to perform various processes based on predetermined logic circuit(s) via one or more processors.

Each processor includes, for example, a central processing unit (CPU), a graphics processing unit (GPU), a digital signal processor (DSP), a field programmable gate array (FPGA), an application specific integrated circuit (ASIC), and/or the like.

Note that the controller 20 may include a plurality of physically separated processors which operate together to perform various processes, and the configuration of the controller 20 is not limited to the above-described configurations. In such a case, the plurality of processors are provided in one or more computers which are physically separated from the working machine 1, and the processors are connected together in a communicable manner via a network such as an in-vehicle network, LAN, WAN, and/or the internet.

The software program(s) may be stored in the storing device 21 (nonvolatile memory such as an HDD, an SSD, a CD-ROM, and/or a DVD-ROM) connected in a communicable manner to the controller 20, and/or in an external server 50 connected via the above-described network(s), and may be installed in the above-described memory (memories) from the storing device 21 and/or the server 50.

As shown in FIG. 1, the working machine 1 includes one or more sensors 25. Each sensor 25 senses a surrounding area of the working machine 1. Specifically, the sensor 25 performs sensing by measuring the distance to a surrounding environment of the working machine 1 (the distance to an object in the surrounding area of the working machine 1). The sensor 25 is a range sensor (distance-measuring sensor) to measure the distance(s) to at least a portion of the surroundings of the working machine 1. The sensor 25 is configured or programmed to measure the distances to at least a portion of the surroundings of the working machine 1 to detect point cloud data of the surrounding environment of the working machine 1.

Each sensor 25 is connected in a communicable manner to the controller 20 via wire or wireless, and outputs a sensed result to the controller 20. The sensor 25 includes an optical range sensor, a signal processing circuit, and the like. The optical range sensor of the sensor 25 may include, for example, light detection and ranging (LiDAR).

The LiDAR sensor (laser sensor) is configured such that a light source such as a laser diode emits pulse measurement light (laser light) millions of times per second, and the measurement light is scanned in a horizontal direction and/or vertical direction by being reflected by a rotating mirror to be projected onto a predetermined detection area (sensed area, for example, 360 degrees). Then, a photoreceptor (photodetector) of the LiDAR receives reflected light which is a portion of the measurement light reflected from the target object. The signal processing circuit detects the distance to the target object based on the time between the emission of measurement light by the LiDAR and the reception of reflected light (Time of Flight (ToF) method).

Note that examples of the optical range sensor of the sensor 25 other than the LiDAR include ToF cameras. In the above-described example, the sensor 25 includes an optical range sensor. However, a sonic range sensor (for example, an aerial ultrasonic sensor such as sonar) may be used instead of the optical range sensor.

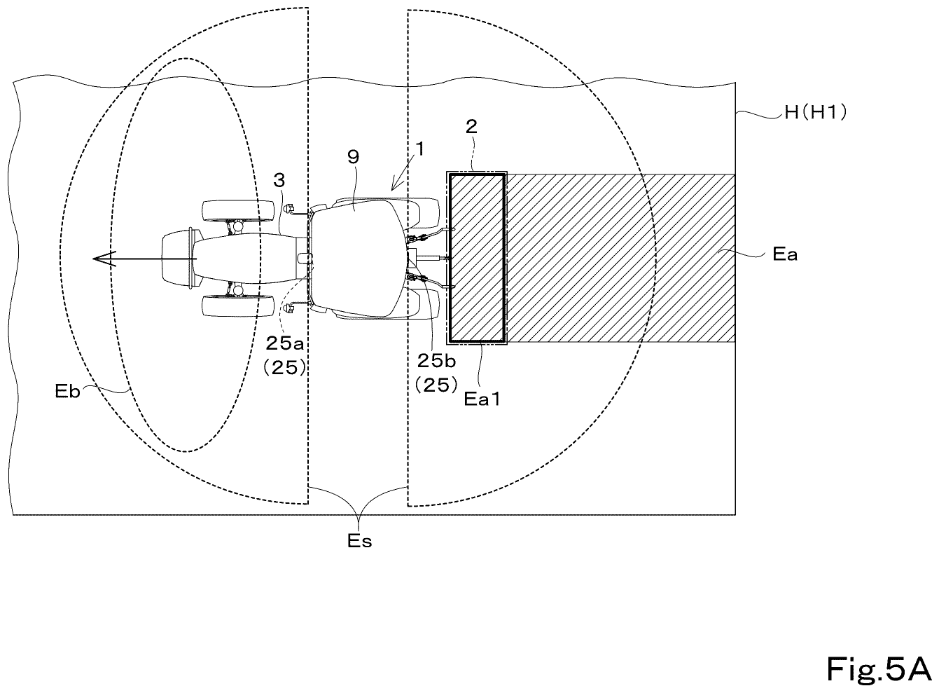

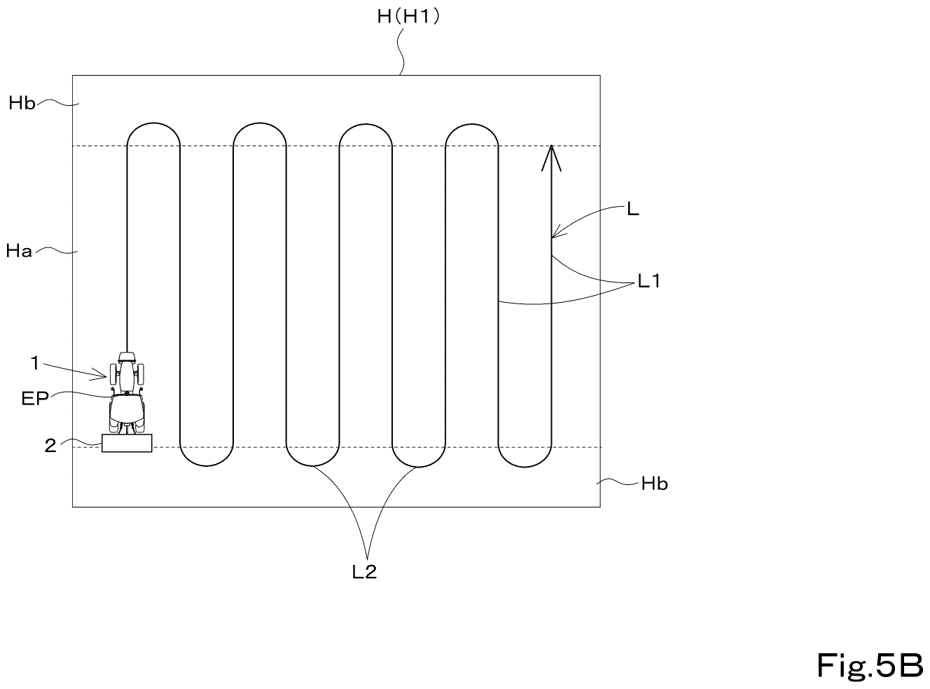

FIG. 5A illustrates an example of sensed area(s) Es covered by sensor(s) 25 provided on the working machine 1. One or more sensors 25 are provided on the working machine 1, and the one or more sensors 25 sense the sensed area(s) Es. The sensed area(s) Es at least include(s) a worked area Ea where the working machine 1 (working device 2) has performed work. The sensor(s) 25 sense(s) a position estimation area Eb for use in estimation of the position of the working machine 1 which includes the sensor 25. The position estimation area Eb may be, for example, an area located in the direction of travel of the working machine 1.

Note that FIG. 5A is only for illustrative purposes to illustrate the sensed areas Es. The sensed area(s) Es, the worked area Ea, and the position estimation area Eb are not limited to the example shown in FIG. 5A. The distance covered by the sensor 25 differs depending also on a range sensor used as the sensor 25.

The working machine 1 performs work while traveling. Thus, a working area Ea1, which is the area where the working machine 1 can perform work (the area where the working device 2 of the working machine 1 which is located at a certain location performs work), moves as the working machine 1 travels. The working area Ea1 is the area where the working device 2 performs work at a certain location, in other words, at a predetermined point in time, when the working machine 1 performs work while traveling. That is, the working area Ea1 refers to an area within which the working machine 1 at a certain location (or a certain point in time) acts on object(s) (agricultural field H1, crops planted in the agricultural field H1, weed in the agricultural field H1, and/or the like).

Note that, in the example shown in FIG. 5A, the working device 2 is attached to a rear portion of the travel vehicle body 3, and a sensor 25 senses an area rearward of the working machine 1 and the working device 2. However, the portion of the sensed area Es that includes an area located in the direction opposite to the direction of travel of the working machine 1 is not limited to the area rearward of the working machine 1 and the working device 2. For example, in the case where the working device 2 is attached to the travel vehicle body 3 such that the working device 2 is offset in the width direction relative to the travel vehicle body 3, in other words, in the case where the working area Ea1 is offset in the width direction relative to the travel vehicle body 3, the portion of the sensed area Es that includes an area located in the direction opposite to the direction of travel of the working machine 1 includes the working area Ea1 offset in the width direction relative to the travel vehicle body 3.

In the present example embodiment, the direction of travel of the working machine 1 is a forward direction or a rearward direction. Thus, the sensors 25 can sense area(s) including at least an area forward of and an area rearward of the working machine 1, as a surrounding area of the working machine 1. In the example shown in FIGS. 2 and 3, the working machine 1 includes two sensors 25. One of the sensors 25 (first sensor 25a) senses an area in front thereof, and the other of the sensors 25 (second sensor 25b) senses an area reared thereof. For example, the first sensor 25a is provided at a front portion of a roof 9a of the cabin 9A. The second sensor 25b is provided at a rear portion of the roof 9a.

The first sensor 25a does not sense the area in which device(s) and apparatus(es) such as the cabin 9A including the roof 9a of the working machine 1 are detected. Thus, the first sensor 25a performs sensing of the area in front of or substantially in front of the working machine 1 (for example, a 180-degree area around the working machine 1), and detects point cloud data of the sensed area Es.

The second sensor 25b does not sense the area in which device(s) and apparatus(es) such as the cabin 9A including the roof 9a of the working machine 1 are detected. It is noted here that the second sensor 25b may acquire the position of the working device 2 connected to the position changer 8A, and exclude the area in which the working device 2 is detected. Thus, the second sensor 25b performs sensing of the area located rearward of or substantially rearward of the working machine 1 (for example, a 180-degree area around the working machine 1), and detects point cloud data of the sensed area Es.

With the above-described configuration, in the present example embodiment, it is possible to perform sensing of a 360-degree or substantially 360-degree area around the working machine 1 using the first sensor 25a and the second sensor 25b. Note that it is only necessary that one or more sensors 25 be provided on the working machine 1 and that the surrounding area of the working machine 1 be sensed by the one or more sensors 25. Such a sensed area Es is not limited to a 360-degree or substantially 360-degree area around the working machine 1, and the position(s) at which the sensor(s) 25 is/are attached is/are not limited to the above-described positions. In FIG. 5A, the sensed area Es is a 360-degree or substantially 360-degree area around the working machine 1 that may include a blind spot of the sensor, but this does not imply any limitation. Note that, in the present example embodiment, the working device 2 is a ridger. Thus, the sensed area Es need only be an area where at least formed objects M (for example, ridges M1) can be detected. The sensed area Es in the present example embodiment is located on the same side of the working machine 1 as the working device 2 and is, for example, a 180-degree or substantially 180-degree area rearward of the working machine 1, but may be a 90-degree area or the like, and these numbers do not imply any limitation.

As shown in FIG. 1, the working machine 1 includes an imager 26. The imager 26 may be a charge coupled device (CCD) camera including a CCD image sensor, a complementary metal oxide semiconductor (CMOS) camera including a CMOS image sensor, and/or the like. The imager 26 is provided at a front portion of the roof 9a. The imager 26 captures an image of an area in front of the working machine 1, and the captured image includes what is going on in front of the working machine 1. The first sensor 25a and the imager 26 are arranged adjacent to each other in the vertical or horizontal direction at the front portion of the roof 9a. Thus, the point cloud data of the sensed area Es obtained by the first sensor 25a and the image captured by the imager 26 are taken from the same or substantially the same measurement points (points of view).

In the case where a ROPS is provided as the protection structure 9, a single sensor 25 may be provided at an upper portion of the ROPS. A pair of sensors 25 may be provided on attachment structures extending outward along the width direction of the travel vehicle body 3 from each of the front and rear portions of the travel vehicle body 3 such that the pair of sensors 25 are separated outward from the travel vehicle body 3 along the width direction from the travel vehicle body 3 at each of the front and rear portions of the travel vehicle body 3. Additionally or alternatively, one or more sensors 25 may be provided on the working device 2 to be attached to and detached from the travel vehicle body 3. The first sensor 25a and the imager 26 are adjacent to each other and arranged horizontally or vertically at an upper portion of the ROPS.

As shown in FIG. 1, the working machine 1 includes a position estimator 20a to estimate the position of the working machine 1 based on the sensed result(s) from the sensor(s) 25. The position estimator 20a includes, for example, software program(s) installed in the controller 20. As another example, in the case where the working machine 1 is connected in a communicable manner directly or indirectly to an information processor such as the external server 50, the position estimator 20a may be provided in the external server 50 or the like external to the working machine 1. The following describes an example where the controller 20 (working machine 1) includes the position estimator 20a, and detailed descriptions of other examples are omitted here.

The position estimator 20a estimates the position of the working machine 1 based on the sensed result(s) from the sensor(s) 25 and based on environmental map information. The position estimator 20a performs the position estimation based on the sensed result(s) from the sensor(s) 25 (ranging signal(s) (measured distance signal(s)) from the range sensor(s)), based on the environmental map information, and based on a simultaneous localization and mapping (SLAM) algorithm.

The environmental map information is map information indicating objects in the environment of an area including a work site H in which the working machine 1 performs work, and includes point cloud data. In the case where, for example, the work site H is an agricultural field H1 and the environmental map information indicates the environment of an area including the agricultural field H1, the environmental map information includes the ground in the area including the agricultural field H1, crops planted in the agricultural field H1, ridge(s) M1 on the agricultural field H1, passageway(s) around the agricultural field H1, fence(s) around the agricultural field H1, weed on the ground in the area including the agricultural field H1, barn(s) in the area including the agricultural field H1, and/or the like each of which is in the form of three-dimensional point clouds. The environmental map information is generated in advance based on the sensed result(s) from the sensor(s) 25 and stored in the storing device 21. Note that the environmental map information stored in the storing device 21 may be generated based on sensed result(s) from sensor(s) 25 of another working machine 1 or the like.

The position estimator 20a estimates the position of the working machine 1 in the following manner. The position estimator 20a acquires point cloud data (detected point cloud data) from the sensed result(s) from the sensor(s) 25 of the working machine 1, and positions the acquired point cloud data with respect to the point cloud data of the environmental map information (performs matching) to estimate the position of the working machine 1. The position estimator 20a estimates the position of a predetermined portion of the working machine 1, as the position of the working machine 1.

The position estimator 20a may estimate the position of the working machine 1 (travel vehicle body 3) (i.e., performs the position estimation to obtain the estimated position EP), based on the position of the position detector 27 attached to the working machine 1 detected by the position detector 27 using a satellite positioning system (positioning satellite(s)) such as D-GPS, GPS, GLONASS, BeiDou, Galileo, and/or Michibiki, i.e., based on the position (for example, latitude and longitude) of a GPS antenna. In such a case, the position estimator 20a may use the position (for example, latitude and longitude) of the position detector 27 detected by the position detector 27 without using the sensed results from the sensor(s) 25 or the environmental map information.

As shown in FIG. 1, the controller 20 includes an automatic operation controller 20b. The automatic operation controller 20b includes electric/electronic circuit(s), CPU(s), program(s) stored in memory (memories), and/or the like which are provided in the controller 20.

The automatic operation controller 20b is configured or programmed to control automatic operation of the working machine 1 (such a control may be hereinafter referred to as “automatic operation control”). The automatic operation controller 20b is configured or programmed to perform line-based automatic operation control and/or autonomous-based automatic operation control. The automatic operation control is described below using the line-based automatic operation control as an example. The automatic operation controller 20b is configured or programmed to control equipment and device(s) of the working machine 1 based on the estimated position EP and based on a predefined planned travel route (path) L so that the travel vehicle body 3 travels along the planned travel route L. For example, the automatic operation control performed by the automatic operation controller 20b includes controlling the steering angle and the travel speed (vehicle speed) of the travel vehicle body 3.

The planned travel route L may be stored in advance in the storing device 21, or may be created (defined) based on the estimated position EP estimated by the position estimator 20a when the working machine 1 actually travels. The planned travel route L may be created based on information inputted via an input interface.

The input interface is, for example, a display 15 provided in or on the working machine 1 to receive input actions. The display 15 includes a display screen, and also, for example, a touch pad, hardware switch(es), and/or the like. It is only necessary that the input interface can at least be operated to receive input of information and that the controller 20 acquire the inputted information. The input interface may be an operable terminal such as a smartphone connected in a communicable manner to the controller 20. The input interface may be a communicator to communicate with the external server 50 and/or the like, and the communicator may receive the planned travel route L managed in the external server 50 or the like.

During automatic operation control, the automatic operation controller 20b controls the steering angle such that the position deviation of the estimated position EP from the planned travel route L is less than a threshold. That is, in the case where the position deviation of the estimated position EP from the planned travel route L is less than a threshold, the automatic operation controller 20b controls the control valve 35 of the steering system 11 to keep the steering angle. On the contrary, in the case where the position deviation of the estimated position EP from the planned travel route L is equal to or greater than the threshold, the automatic operation controller 20b controls the control valve 35 of the steering system 11 to change the steering angle in a direction that reduces the position deviation.

The following description discusses the automatic operation control in the case where the working machine 1 performs work in the agricultural field H1. For example, the automatic operation controller 20b performs the automatic operation control such that the working machine 1 travels back and forth between a first edge and a second edge of the work site H (agricultural field H1). FIG. 5B illustrates the planned travel route L. As shown in FIG. 5B, the planned travel route L on the agricultural field H1 includes (i) straight portions L1 extending between the first and second edges of the agricultural field H1, and (ii) turn portion(s) L2 each connecting one of the straight portions L1 and another of the straight portions L1.

The automatic operation controller 20b may be configured or programmed to control the working device 2, the position changer 8A, and/or the like to control work performed by the working device 2, based on the position of the working machine 1 with respect to the planned travel route L and/or the like. The automatic operation controller 20b is configured or programmed to control performing and stopping of work by the working device 2. The automatic operation controller 20b is configured or programmed to control the driving of the position changer 8A (lifter) and the PTO shaft 6 to switch between a work state in which the working device 2 performs work and a non-work state in which the working device 2 does not perform work.

The following description discusses an example case in which the working device 2 is operable to be towed by the working machine 1 to perform work while in contact with or engaged in the ground surface, such as a tiller or a ridger. The automatic operation controller 20b is configured or programmed to achieve a work state by causing the position changer 8A to lower the working device 2 to the ground, and achieve a non-work state by causing the position changer 8A to raise the working device 2 from the ground.

In the case where the working device 2 is driven by power transmitted from the PTO shaft 6 or driven by an actuator (e.g., electric actuator) provided therein, like a rotary tiller or a baler, the automatic operation controller 20b is configured or programmed to switch between the work state and the non-work state by controlling such a power source (PTO shaft 6, actuator, or the like).

For example, the automatic operation controller 20b achieves the work state when the estimated position EP is on the straight portion(s) L1, and achieves the non-work state when the estimated position EP is on the turn portion(s) L2.

The automatic operation controller 20b may perform switching between the work state and the non-work state depending on the area(s) defined within an agricultural field map, instead of the estimated position EP along the planned travel route L. For example, an area in which work is performed (work area Ha) is defined in an area radially inward of headland(s) of the agricultural field H1. An area in which work is not performed (non-work area Hb) is defined in the headland(s) of the agricultural field H1, in entrance/exit of the agricultural field H1, and in an area in which work has already been performed. Note that the above-described work area Ha and the non-work area Hb are merely examples, and, for example, the headland(s) may be included in the work area Ha.

Note that in the above-described example embodiment, automatic operation is described using a line-based automatic operation control as an example. However, during autonomous-based automatic operation control, the automatic operation controller 20b controls equipment and devices provided in the working machine 1 such that the working machine 1 performs work within the agricultural field H1 based on the estimated position and based on the sensed results instead of based on the planned travel route L.

The working machine 1 may use a display 15 to display the current position of the working machine 1 on an agricultural field map representing the agricultural field H1, based on the estimated position EP estimated by the position estimator 20a and based on the agricultural field map. The display 15 may be a display positioned, for example, in the vicinity of the seat 10 of the working machine 1, a mobile terminal the user carries, a manager terminal to monitor the work performed by the working machine 1, or the like. Examples of the mobile device and the manager terminal include smartphones, tablets, devices such as a PDA, and stationary computers such as personal computers.

The working machine 1 includes a first communicator 29. The first communicator 29 is a communication module configured or programmed to communicate directly or indirectly with a server 50. The first communicator 29 is configured or programmed to perform wireless communication using, for example, a communication standard IEEE802.11 Wireless Fidelity (Wi-Fi, registered trademark), Bluetooth (registered trademark) Low Energy (BLE), Low power wide area (LPWA), Low-power wide-area network (LPWAN), and/or the like. The first communicator 29 is configured or programmed to perform, for example, wireless communication using a mobile phone communication network, a data communication network, and/or the like.

The following discusses the second working machine 1B. The second working machine 1B includes substantially the same configuration as the above-described first working machine 1A, but does not include the sensor 25 or the position estimator 20a. The second working machine 1B includes the position detector 27 and therefore is able to acquire the position thereof. The second working machine 1B includes a third communicator 29B. The third communicator 29B includes the same configuration as the first communicator 29. A detailed description of the portion of the configuration of the second working machine 1B that is the same as the first working machine 1A is omitted here.

The following discusses the server 50. The server 50 includes a second communicator 51, a storing device (memory and/or storage) 52, and a controller 53. The second communicator 51 is, similar to the first communicator 29, a communication module configured or programmed to communicate directly or indirectly with the working machine(s) 1. The second communicator 51 is configured or programmed to perform, for example, wireless communication using a mobile phone communication network, a data communication network, or the like. The storing device 52 is, for example, a hard disk drive (HDD), a solid state drive (SSD), and/or the like.

The controller 53 performs various controls relating to the server 50. The controller 53 includes one or more memories, analog circuit(s), digital circuit(s), and/or the like. The one or more memories contain (store) software program(s) to be executed by one or more processors and various data. The controller 53 is configured or programmed to use the one or more processors to read software program(s) from the one or more memories and perform various processes based on the software program(s). Note that the controller 53 may be configured or programmed to perform various processes based on predetermined logic circuit(s) via the one or more processors. Examples of the processors include CPU, GPU, DSP, FPGA, and ASIC.

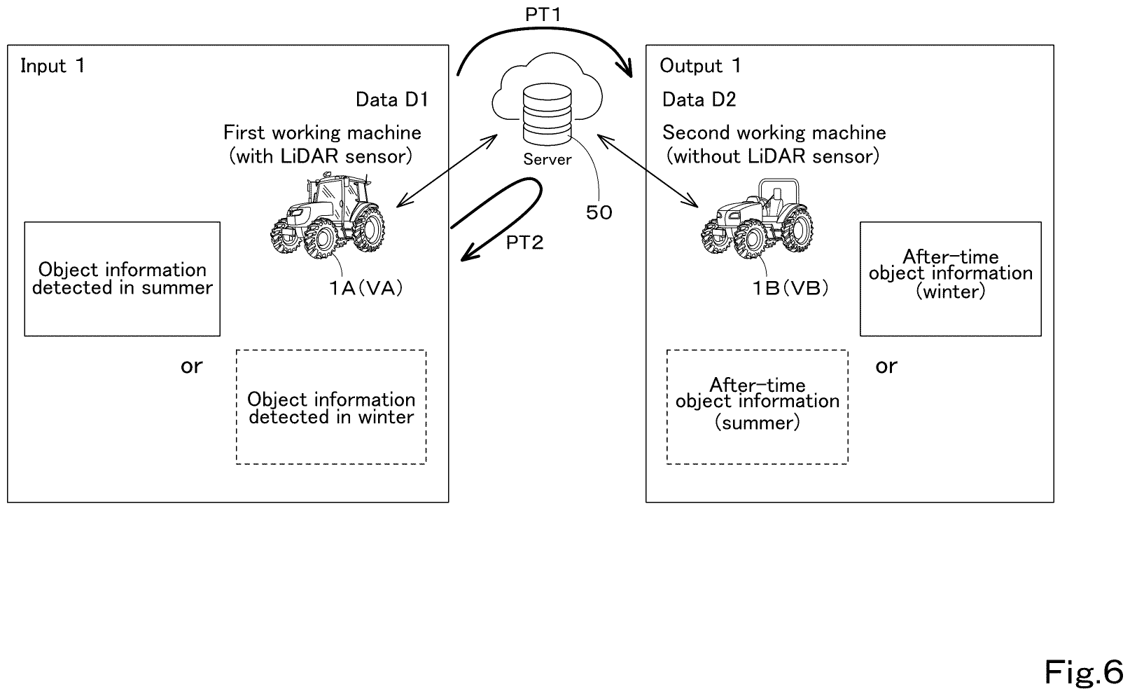

The following describes an example of the functions of the assist system S. FIG. 6 illustrates the assist system S in which the object information detected by the first working machine 1A is made use of by the second working machine 1B. Assume that, as shown in FIG. 6, the first working machine 1A transmits, to the server 50, object information indicating objects in the surrounding area detected by the first sensor 25a of the first working machine 1A in the summer period (such object information is referred to as, for example, object information detected in summer). The server 50 stores the object information detected in summer. The server 50, for example, in the case where the server 50 receives a transmission request from the second working machine 1B during the winter period, transmits, to the second working machine 1B, after-time object information (winter) obtained by correcting the object information in summer. The second working machine 1B is operable to autonomously travel using the after-time object information (winter) in the winter period.

Alternatively, as shown in FIG. 6, if object information detected in winter is transmitted from the first working machine 1A to the server 50, the server 50 stores the object information detected in winter. The server 50, for example, in the case where the server 50 receives a transmission request from the second working machine 1B during the summer period, transmits, to the second working machine 1B, after-time object information (summer) obtained by correcting the object information detected in winter. The second working machine 1B is operable to autonomously travel using the after-time object information (summer) in the summer period.

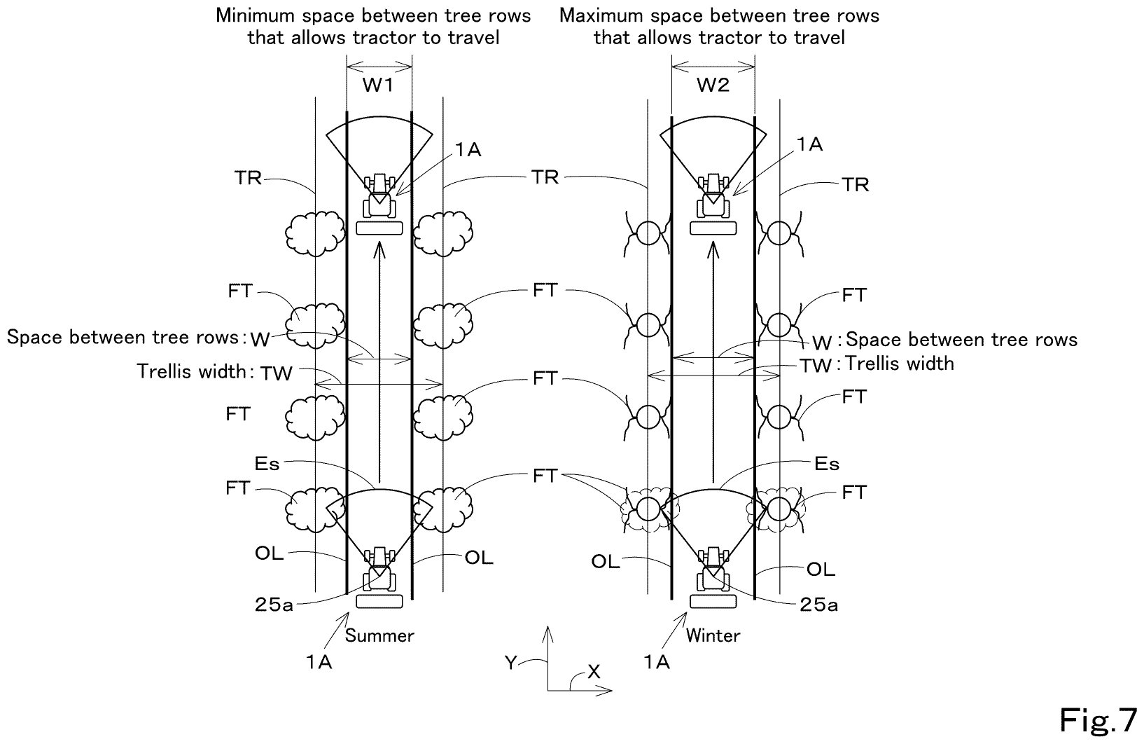

FIG. 7 illustrates summer in which the space between tree rows is a minimum space (width) W1, and winter in which the space between tree rows is a maximum space (width) W2. As illustrated in the left portion of FIG. 7, in the agricultural field H1 (for example, a vineyard), a plurality of (two in FIG. 7) tree rows TR are arranged in a lateral direction perpendicular to a predetermined direction Y. Each of the plurality of tree rows TR includes a plurality of fruit trees FT (grape vines in the present example embodiment) planted with a space therebetween in the predetermined direction Y. In summer, since leaves grow thick on the grape vines, the distance between outer end positions OL of two adjacent tree rows TR that face each other (i.e., the distance between tree rows (width/space between vine rows)) is the minimum width W1. That is, the space W between tree rows that allows the first working machine 1A (for example, a tractor) to travel is the minimum width W1. In some cases, trellises (for example, support poles) are added to support the fruit trees FT, and the space between the tree rows is referred to as a trellis width (space between trellises). Note that “trellis” refers to a tree row forming system including support poles (rods) with cross pieces or wires to support trees. As the first working machine 1A travels between the tree rows in summer, the first sensor 25a of the first working machine 1A detects objects in the surrounding area (for example, the tree rows TR on both sides). That is, the first sensor 25a acquires object information which is information about objects in the surrounding area. This object information is object information detected in summer, which includes point cloud data including thickly grown tree rows TR on both sides of the travel route of the first working machine 1A.

On the contrary, as illustrated in the right portion of FIG. 7, in winter, since the fruit trees are sparse compared to summer because leaves of the grape vines are withered and pruned, the space between tree rows is the maximum width W2. That is, the space W between tree rows that allows the first working machine 1A (for example, a tractor) to travel is the maximum width W2 (the maximum width W2 is larger than the minimum width W1). As the first working machine 1A travels between the tree rows in winter, the first sensor 25a of the first working machine 1A detects objects in the surrounding area (for example, fruit trees TR on both sides). That is, the first sensor 25a acquires object information which is information about objects in the surrounding area. This object information is object information detected in winter, which includes point cloud data including withered and pruned tree rows TR positioned at both sides of the travel route of the first working machine 1A. As shown in FIG. 7, specific plants (for example, grape vines) are managed by a farm-related party such that the outer end position OL of each tree row TR moves outward and inward in the width direction periodically (every year).

### First Example Embodiment

The assist system S of the first example embodiment is a system in which an after-time outer end position OL1 (changed end position of grape vines) is calculated by changing, according to the time-of-use in which the second mobile body VB (first working machine 1A or second working machine 1B) uses object information, the outer end position OL of object(s) (end position of grape vines) detected by the sensor 25 of the first mobile body VA (first working machine 1A) so that the after-time outer end position OL1 (changed end position of grape vines) is used effectively.

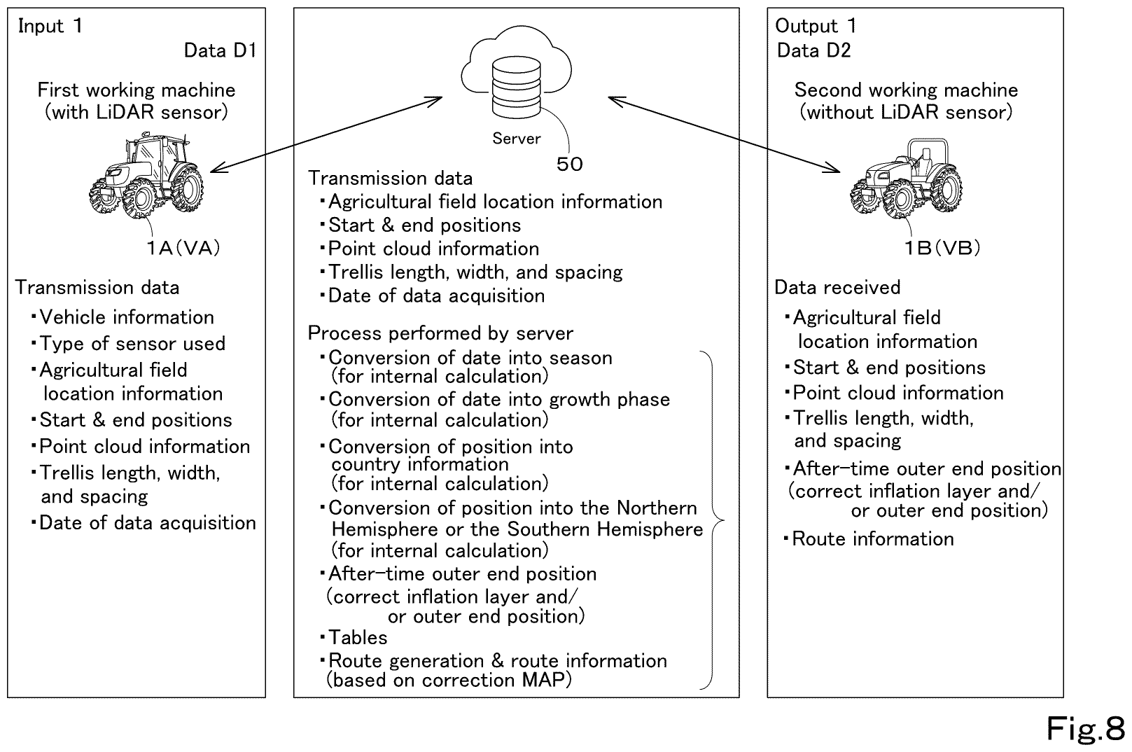

FIG. 8 illustrates an example of a flow of data in the assist system S. As described earlier, the assist system S includes the first mobile body VA (first working machine 1A), the server 50, and the second mobile body VB (which is the first working machine 1A or the second working machine 1B, but is the second working machine 1B in FIG. 8). The first working machine 1A includes sensor(s) 25 (in particular, the first sensor 25a) to detect objects in the surrounding area, and a first communicator 29 to transmit, to the server 50, object information (for example, point cloud information) detected by the sensor(s) 25 and detection time information indicating the detection time at which the object information was detected (for example, the date on which data was acquired).

As shown in FIG. 8, the first working machine 1A transmits various transmission data (data D1) to the server 50. The transmission data (data D1) includes vehicle information, the type of sensor used, agricultural field location information, start position and end position, point cloud information (object information), trellis length, trellis width, trellis spacing, date of data acquisition (detection time information) and/or the like. The vehicle information includes, for example, the position information (longitude, latitude) of the first working machine 1A. The type of sensor used is the type of the sensor 25 (LiDAR, ToF camera, airborne ultrasound sensor, and/or the like) of the first working machine 1A. The agricultural field location information is a map of the agricultural field H1, such as a vineyard, or the like. The start position is the position of the first working machine 1A at the time when the point cloud information started to be acquired with regard to one tree row (start point of a tree row). The end position information is the position of the first working machine 1A at the time when the point cloud information stopped being acquired with regard to the one tree row (end point of the tree row). The point cloud information (object information) is point cloud data in absolute coordinates obtained by converting point cloud data in sensor coordinates with the sensor 25 (in particular, the first sensor 25a) as the reference point based on the vehicle information (information of positions of the first working machine 1A from the start position to the end position). The trellis length is the total length of a row of a plurality of trellises arranged in the predetermined direction Y, and is the length of a tree row TR in the redetermined direction Y. The trellis spacing is the space between a plurality of trellises arranged in the predetermined direction Y (distance between adjacent trellises in the predetermined direction Y). As shown in FIG. 7, the trellis width TW is the distance between the centers of tree rows. The distance obtained by subtracting the space W between tree rows (which is the distance, in the lateral direction X, between the outer end position OL of a tree row TR and the outer end position OL of an adjacent tree row TR) from the trellis width TW is the value that varies depending on changes over time. In other words, the distance represented by “trellis width TW−space W between tree rows=2×(TR-OL)” is the distance that varies with season. Note that the space (width) W between tree rows is synonymous with the distance between tree rows. The trellis length, width, and spacing may be values detected by the sensor(s) 25, or may be values inputted by the user. Although the detection time information here includes the date on which the point cloud information (object information) was detected by the sensor(s) 25 (for example, date of data acquisition), the detection time information may include the month, the season or the like at which the data was acquired.

As shown in FIG. 1, the controller 53 of the server 50 includes a calculator 54. The calculator 54 is configured or programmed to calculate, based on the object information and the detection time information from the first mobile body VA (first working machine 1A), the after-time outer end position OL1 of the object(s) in the time-of-use (current temporal information (for example, date, month, season, and/or the like)) during which the second mobile body VB (first working machine 1A or second working machine 1B) uses the object information, by measuring the time from the detection time. For example, the processor(s) of the controller 53 execute(s) determination program(s) to function as the calculator 54. The time-of-use is, for example, (i) a time period in which the first mobile body VA (first working machine 1A) uses object information (information including the outer end position(s) OL of tree row(s) TR) after the first mobile body VA (first working machine 1A) travels in the agricultural field H1 while detecting the object information, (ii) a time period in which the second mobile body VB other than the first mobile body VA uses object information after the first mobile body VA (first working machine 1A) travels in the agricultural field H1 while detecting the object information, (iii) a time period in which object information is used after a predetermined period of time or more from the detection of the object information by the first mobile body VA, or the like.

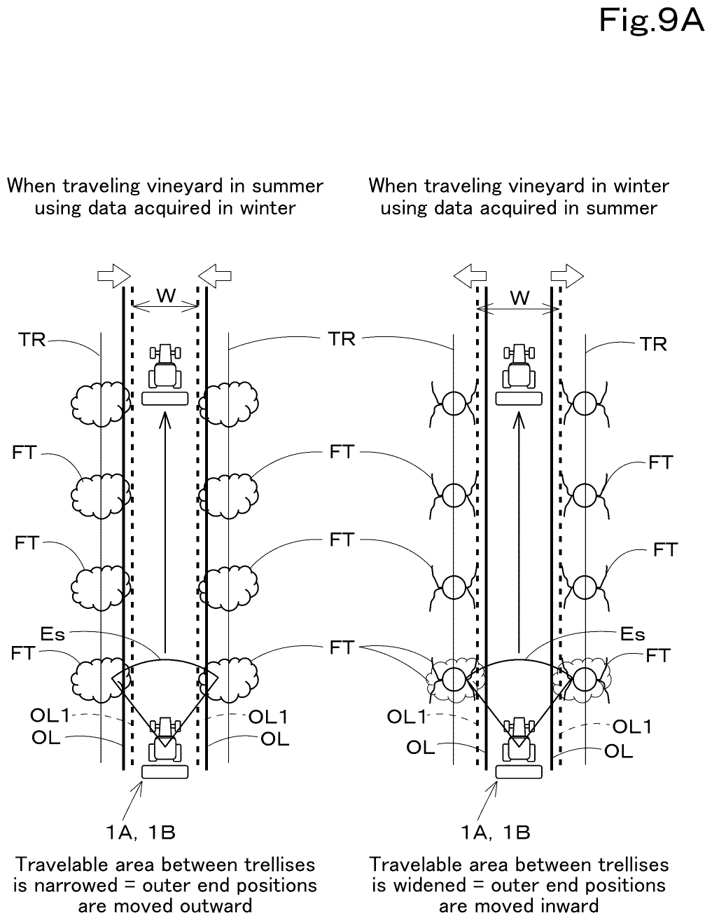

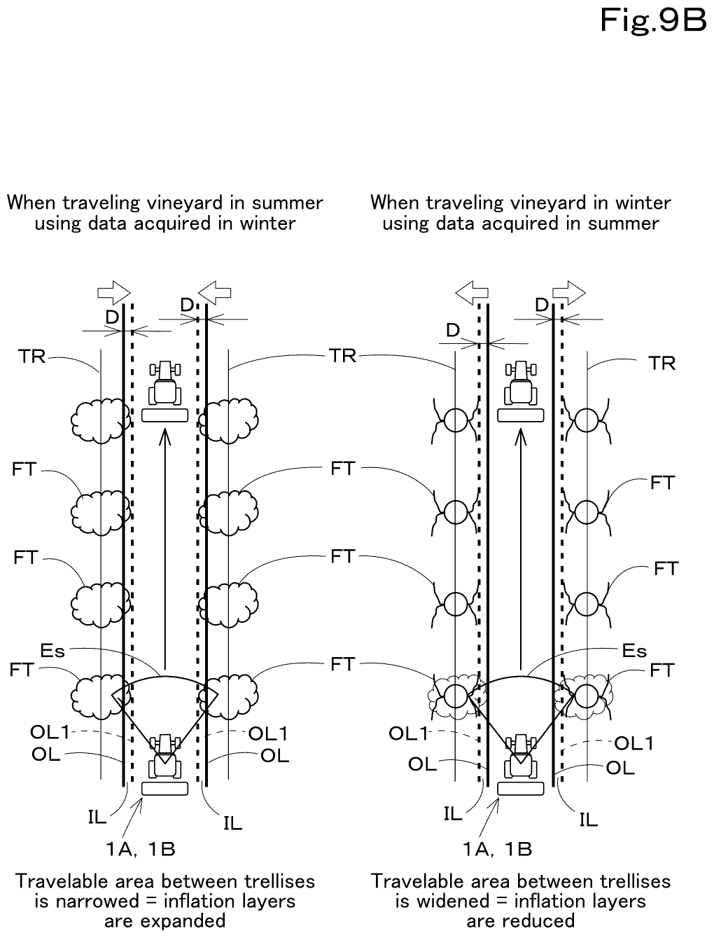

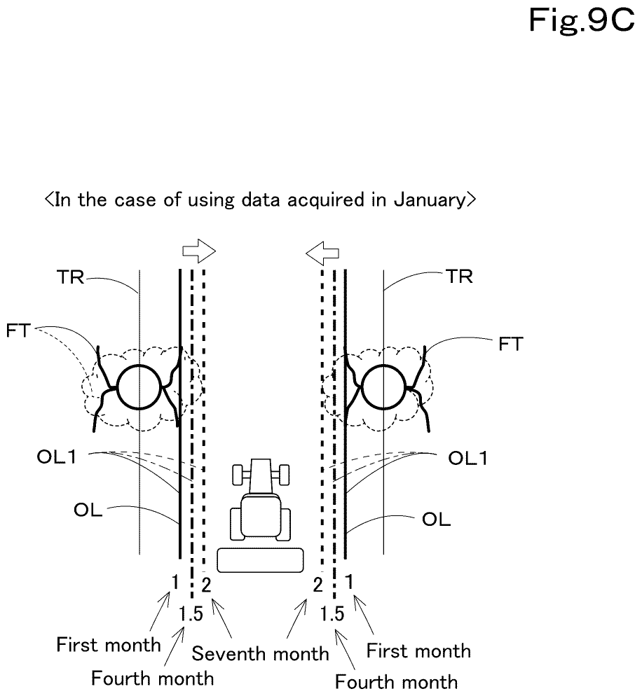

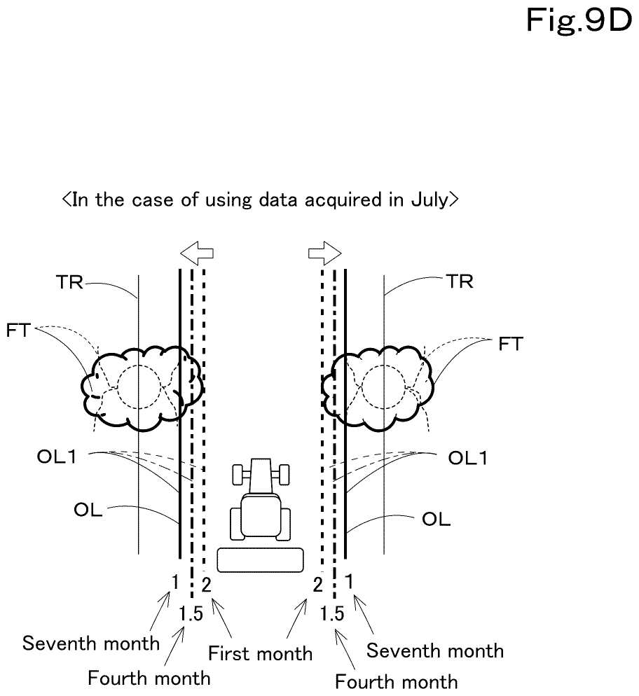

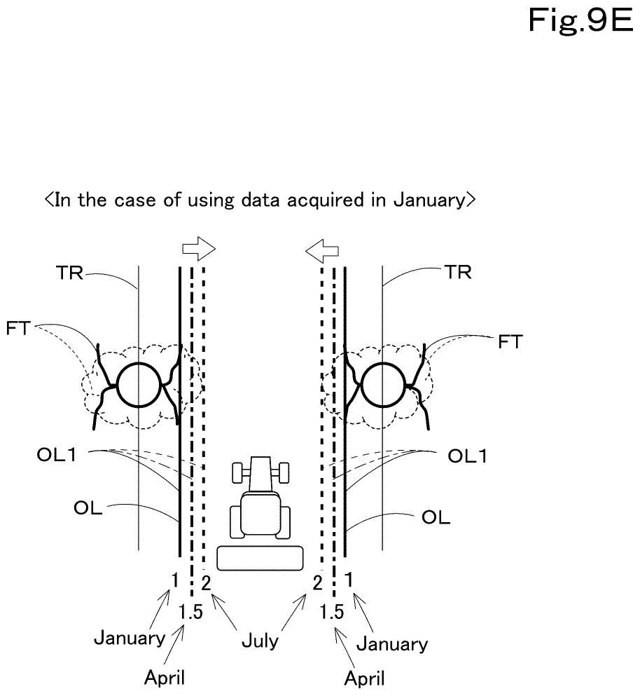

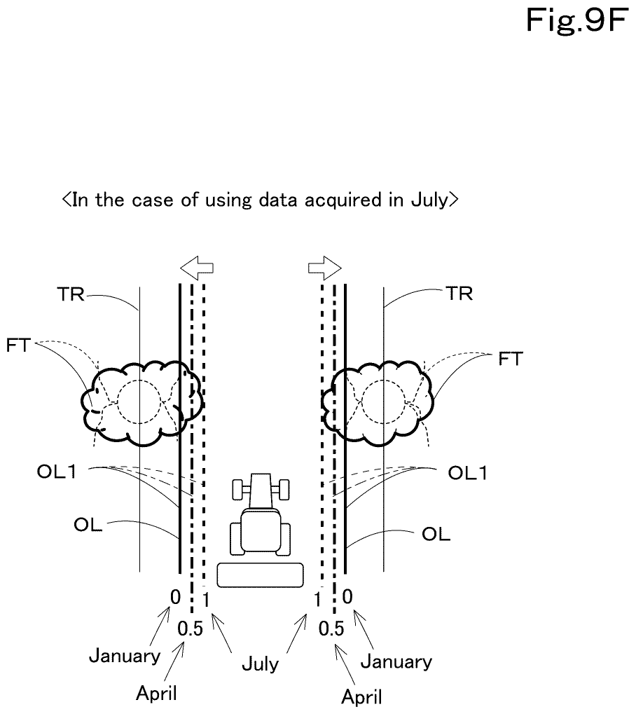

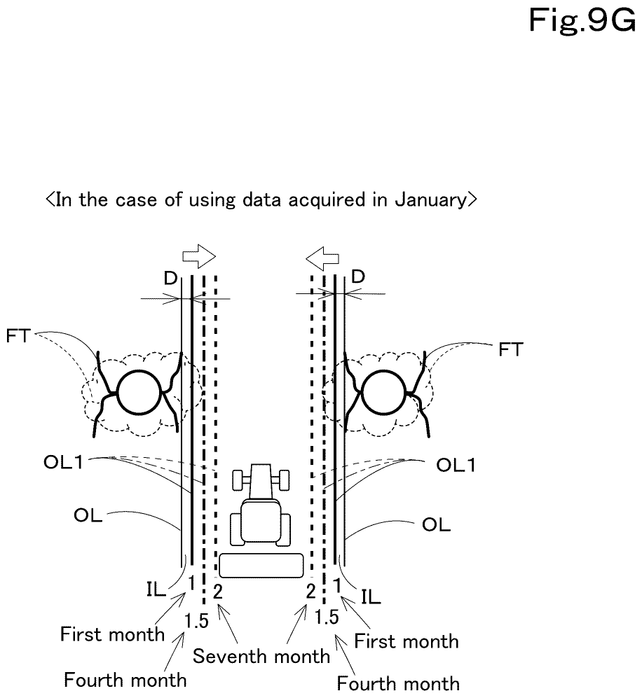

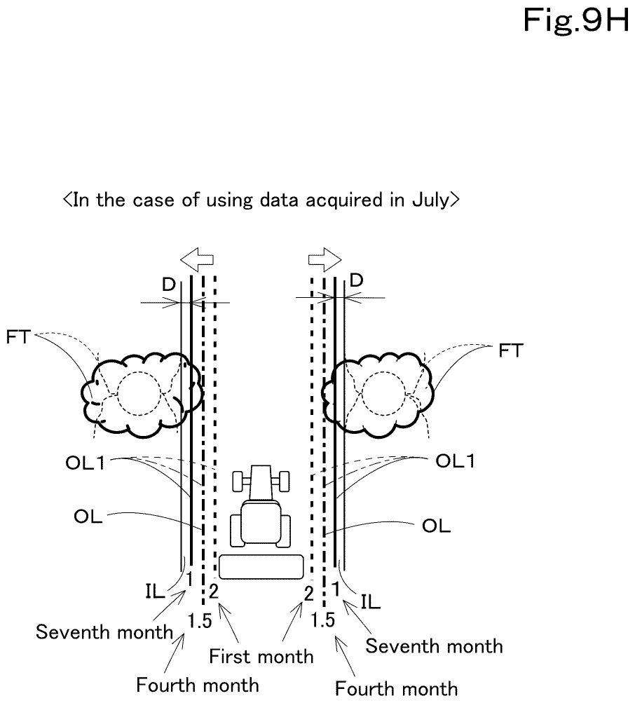

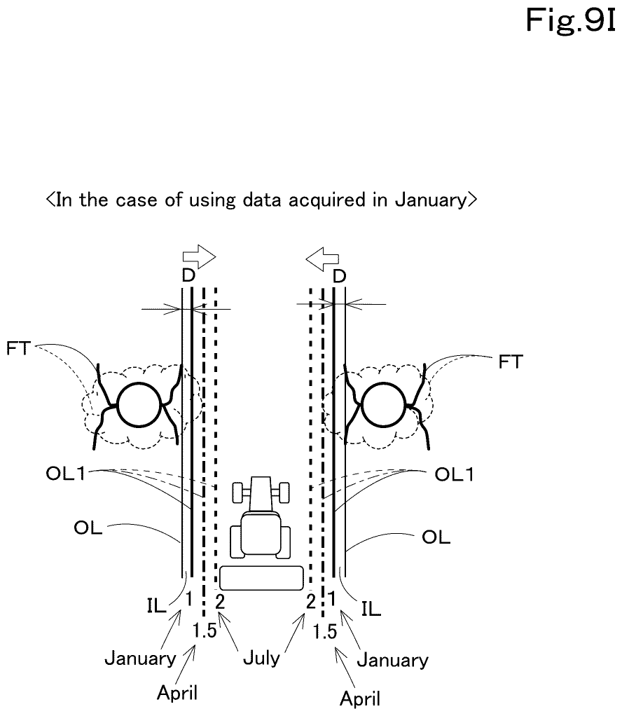

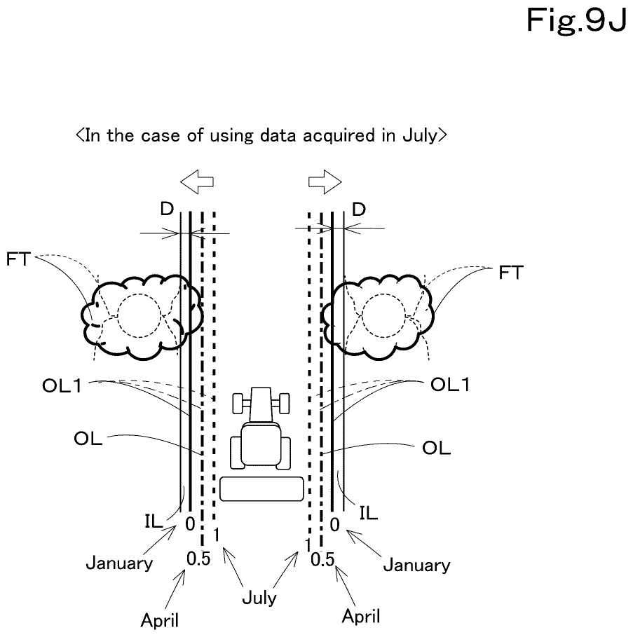

FIG. 9A illustrates the after-time outer end positions OL1 obtained by changing the outer end positions OL depending on the season, in the first example embodiment. As shown in the left portion of FIG. 9A, the calculator 54 calculates, based on the object information acquired in winter as illustrated in the right portion of FIG. 7 and based on the detection time information (the season in which the data was acquired is winter), the after-time outer end positions OL1 of the objects in the time-of-use (for example, the current season is summer) (i.e., the after-time outer end positions OL1 obtained by moving outward the outer end positions OL of the fruit trees in winter) as illustrated in the left portion of FIG. 9A. In this case, as shown in the left portion of FIG. 9A, the distance between the after-time outer end positions OL1, i.e., the space W between tree rows that allows the working machine to travel, is less than that between the outer end positions OL.

On the contrary, the calculator 54 calculates, based on the object information acquired in summer as illustrated in the left portion of FIG. 7 and based on the detection time information (the season in which the data was acquired is summer), the after-time outer end positions OL1 of the objects in the time-of-use (for example, the current season is winter) (i.e., the after-time outer end positions OL1 obtained by moving inward the outer end positions OL of the fruit trees in summer) as illustrated in the right portion of FIG. 9A. In this case, as shown in the right portion of FIG. 9A, the distance between the after-time outer end positions OL1, i.e., the space W between tree rows that allows the working machine to travel, is greater than that between the outer end positions OL.

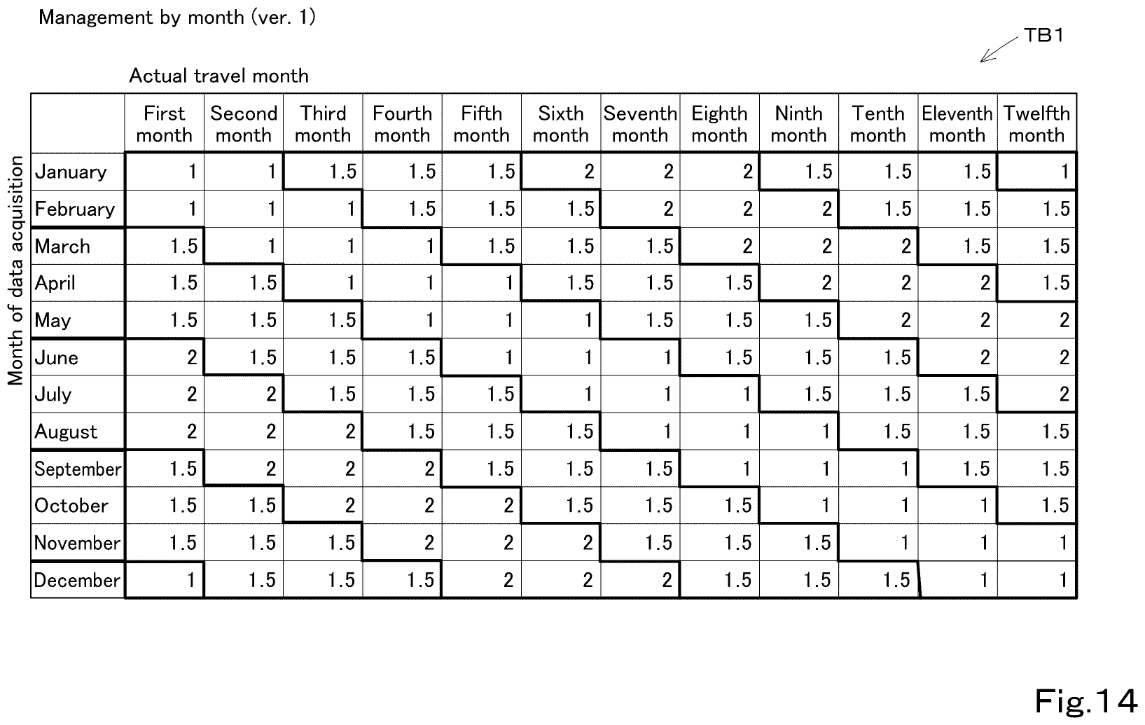

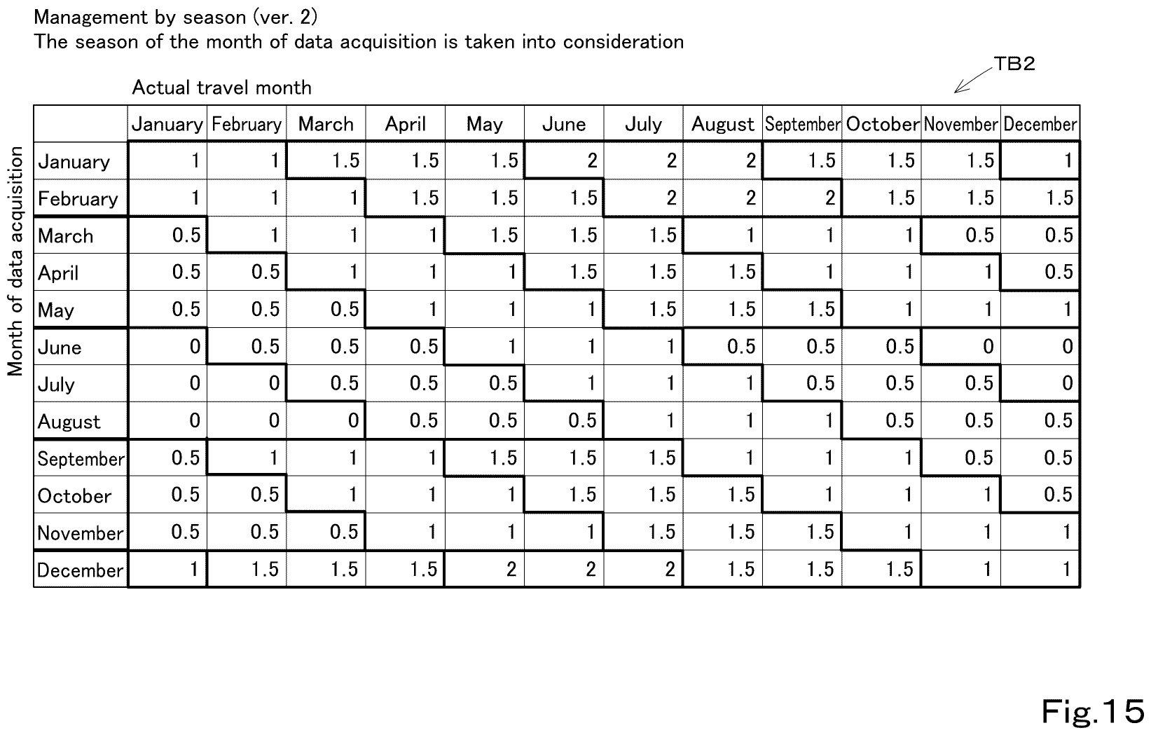

The calculator 54 calculates the after-time outer end positions OL1 by changing the outer end positions OL of the objects at the time of detection based on elapsed time information about the time from the detection time to the time-of-use. For example, the calculator 54 consults a preset table (one of tables TB1 and TB2 shown in FIGS. 14 and 15, described later) indicating a relationship between the detection time, the time-of-use, and the after-time outer end position OL1 to calculate the after-time outer end position OL1. The storing device 52 stores the tables TB1 and TB1 shown in FIGS. 14 and 15 in advance. The calculator 54 determines that the point in time at which a use request for object information is received from the second mobile body VB (for example, the second working machine 1B) is the time-of-use (how many months have passed when the request is received in FIG. 14, or the season when the request is received in FIG. 15), and changes the object information stored in the storing device 52 according to the time-of-use.

The server 50 may include an estimator 55 to identify whether the object(s) is/are plant(s), and, in the case where the object is a plant, estimate the type of the plant and the growth state of the plant. For example, the estimator 55 is configured or programmed to identify the type of the plant using image matching between an image of a plant (for example, fruits such as grapes, apples, or peaches, or vegetables such as potatoes, asparagus, or cabbages) captured by the imager 26, and images of plants stored in advance in the storing device 52. The estimator 55 is configured or programmed to estimate the growth state of the identified plant using image matching between the image of the identified plant and growth state images indicating the growth states of plants stored in advance in the storing device 52. The calculator 54 then calculates an after-time outer end position OL1 by changing the outer end position OL of the objects at the detection time based on the current growth state of the plants. For example, the processor(s) of the controller 53 execute estimation program(s) to function as the estimator 55. Note that the estimator 55 may be configured or programmed to perform at least one of (i) a function to identify crops, (ii) a function to consult pre-input crop information to estimate the growth state, or (iii) a function to perform estimation using image processing. In the case where crop information such as the name of a crop and/or the type of crop is inputted in advance by the user, the server 50 may identify the type of a plant (that is, identify a crop) based on the inputted crop information. For example, in the case where “Cabernet Sauvignon” is inputted, the server 50 not only identifies the plant as grapes but also identifies it as a type of grape for red wine.

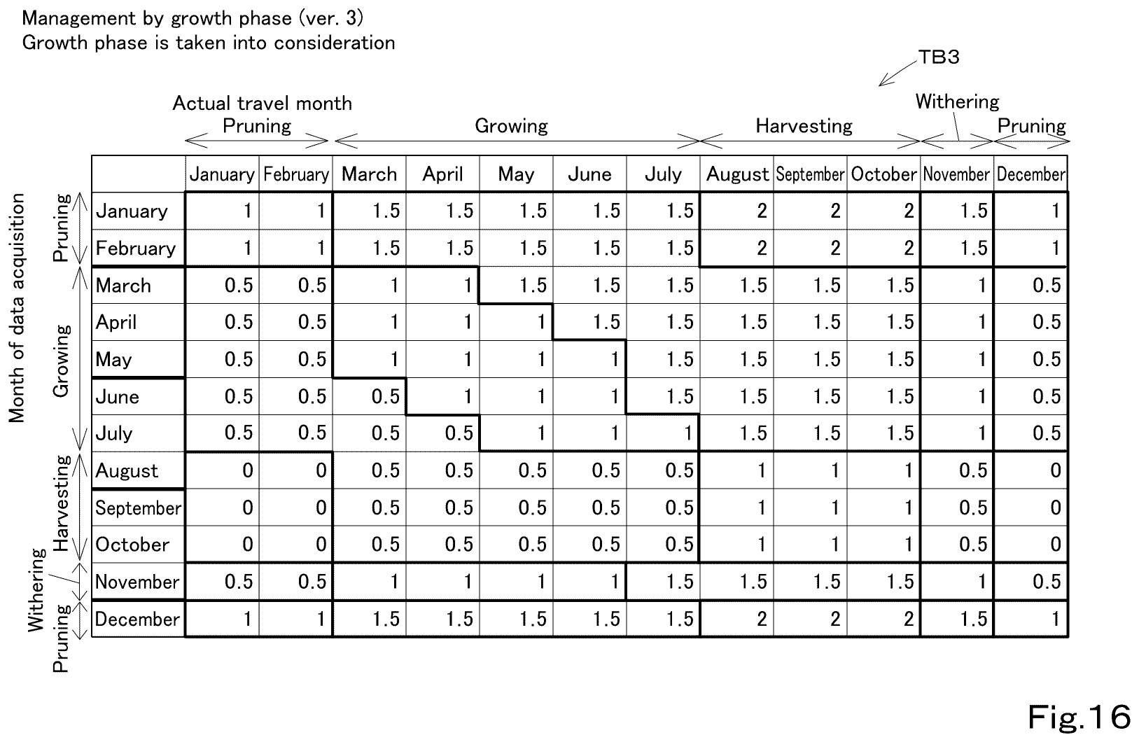

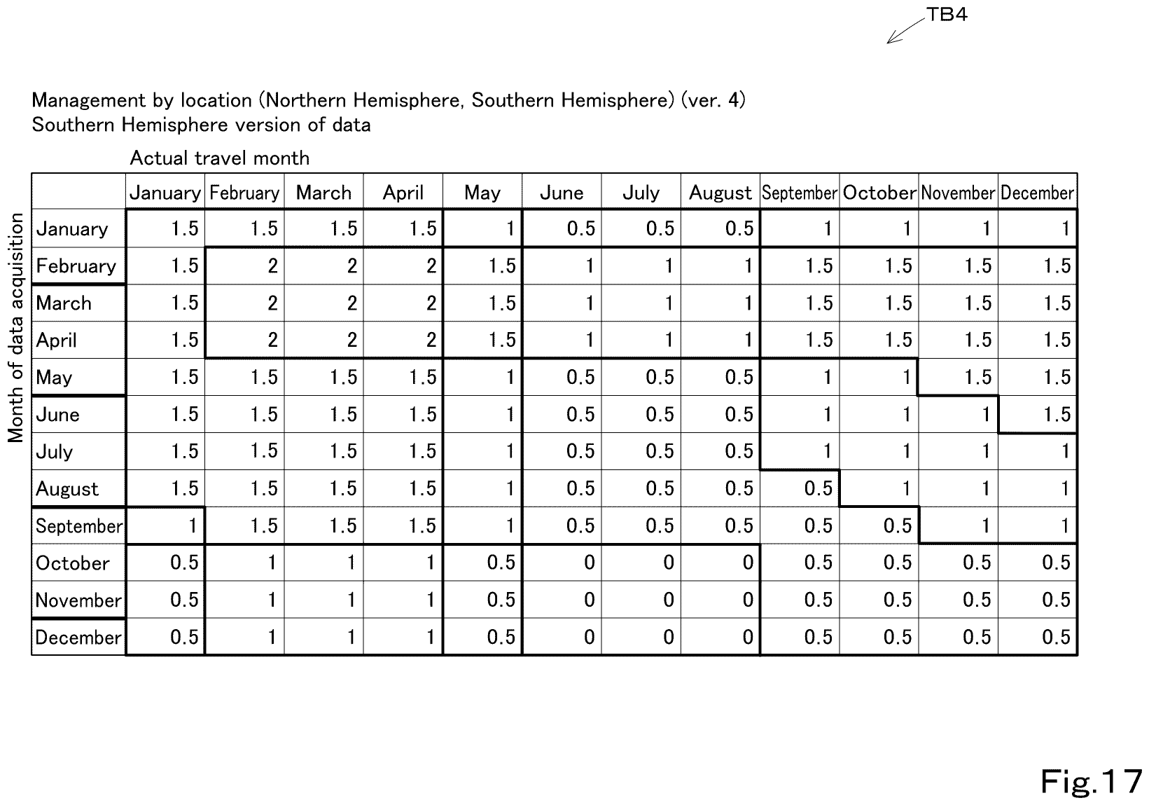

The calculator 54 may consult a pre-set growth table TB3 indicating the relationship between the detection time, the current growth state, and the after-time outer end position OL1 (shown in FIG. 16, described later) to calculate the after-time outer end position OL1. The storing device 52 stores the growth table TB3 shown in FIG. 16 in advance. The calculator 54 determines that the point in time at which a use request for object information was received from the second mobile body VB (for example, the second working machine 1B) is the time-of-use (growth phase in which the object information is used), and changes the object information stored in the storing device 52 according to the time-of-use (the growth phase at the time when the object information is used, in FIG. 16). The calculator 54 may determine country information indicating the country where the agricultural field is located, and may determine hemisphere information indicating whether the agricultural field is located in the Northern Hemisphere or the Southern Hemisphere, based on the position information of the first working machine 1A. Thus, the country information and the hemisphere information are used to determine which of the table for the Southern Hemisphere and the table for the Northern Hemisphere to use to make corrections. That is, if the hemisphere information relating to the first working machine 1A indicates the Southern Hemisphere, corrections are made using the table for the Southern Hemisphere for the second working machine 1B located in the Southern Hemisphere. The storing device 52 stores in advance a growth table TB4 for the Southern Hemisphere shown in FIG. 17 (described later). The calculator 54 may consult the pre-set growth table TB4 for the Southern Hemisphere (FIG. 17) indicating the relationship between the detection time, the current growth state, and the after-time outer end position OL1 to calculate the after-time outer end position OL1.

The estimator 55 identifies whether the object(s) is/are fruit tree(s) FT. In the case where the objects are fruit trees FT, the calculator 54 calculates the after-time outer end position OL1 of a tree row TR that is a line connecting, in the predetermined direction Y, a plurality of outer end positions OL of the plurality of fruit trees FT arranged at interval(s) in the predetermined direction Y.

As has been described, as shown in FIG. 8, the calculator 54 of the server 50 performs internal calculations such as conversion to season, conversion to growth phase, conversion to country information, and conversion to hemisphere, calculation of the after-time outer end position OL1, generation of a route, and calculation of route information.

The second communicator 51 of the server 50 transmits the after-time outer end position OL1 to the second mobile body VB (first working machine 1A or second working machine 1B). In FIG. 1, the second mobile body VB is a second working machine 1B that includes a position detector 27 to detect the position thereof but does not include a sensor 25. That is, since the second working machine 1B does not have the function to generate a route to be traveled by the second working machine 1B (i.e., the travel route thereof), in the case where the route to be traveled by the second working machine 1B is provided from an external device, the second working machine 1B is able to travel based on the route to be traveled by the second working machine 1B and based on the position thereof detected by the position detector 27.

As shown in FIG. 1, the server 50 includes a route (path) generator 56 to generate a route to be traveled by the second mobile body VB. The route generator 56 is configured or programmed to generate the route to be traveled by the second mobile body VB based on the position information of the second mobile body VB acquired by the server 50, and based on the after-time outer end position OL1 calculated by the calculator 54. As shown in FIG. 8, the second communicator 51 transmits, to the second mobile body VB, the route to be traveled by the second mobile body VB generated by the route generator 56.

In the assist system S shown in FIG. 8, the working machine 1 on the output side of the server 50 is the second working machine 1B which does not include sensors 25. That is, the assist system S shown in FIG. 8 has a configuration of a second pattern PT2 including the first working machine 1A, the server 50, and the second working machine 1B. In the assist system S, the working machine 1 on the output side of the server 50 may be the first working machine 1A that includes sensor(s) 25. That is, the assist system S may have a configuration of a first pattern PT1 including the first working machines 1A and the server 50. Examples of the assist system S of the first pattern PT1 include an assist system S including a single working machine 1A and a server 50 (the single working machine 1A functions both as a working machine on the input side and a working machine on the output side), and an assist system S including a first working machine 1A, a server 50, and another first working machine 1A.

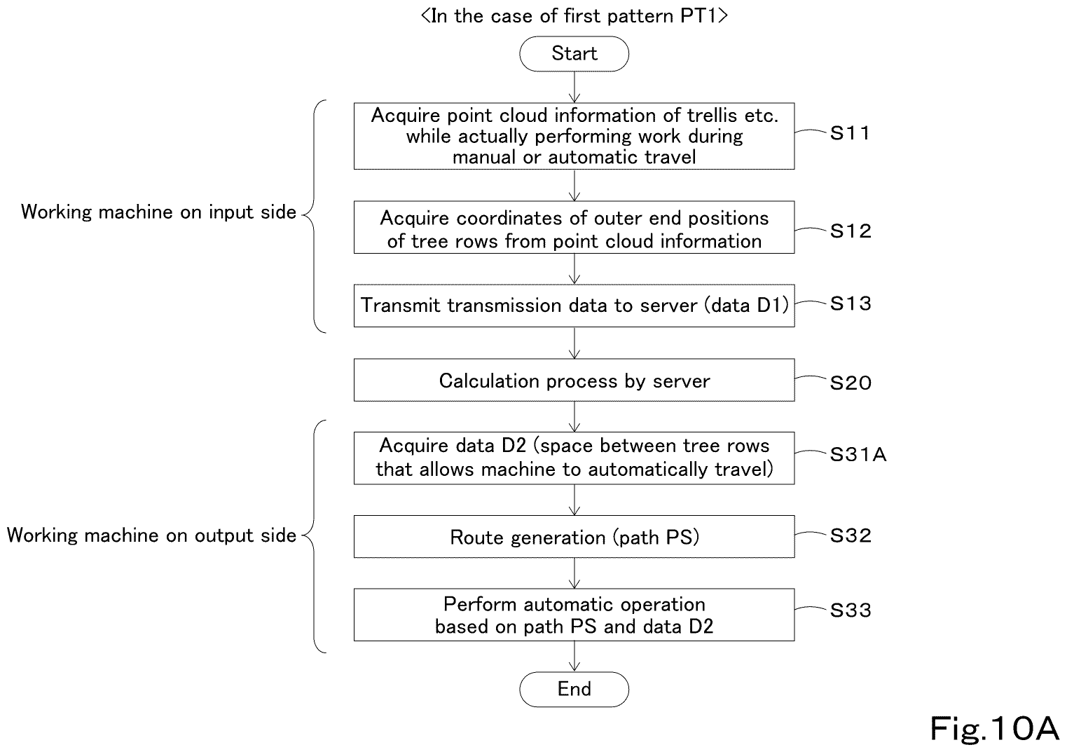

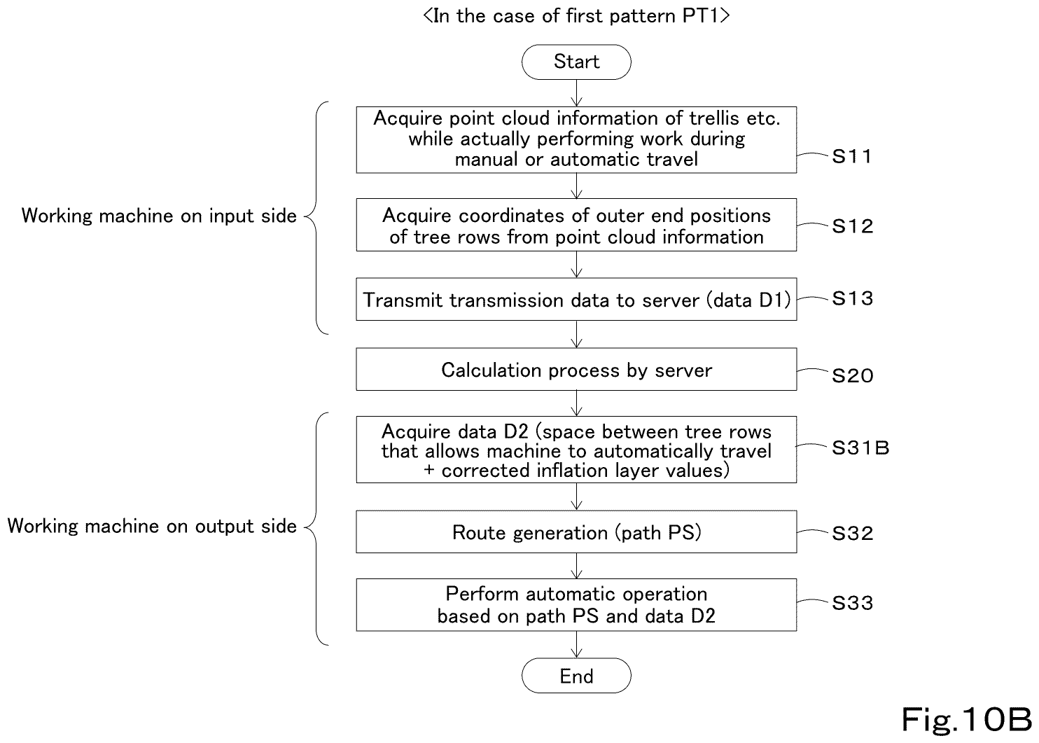

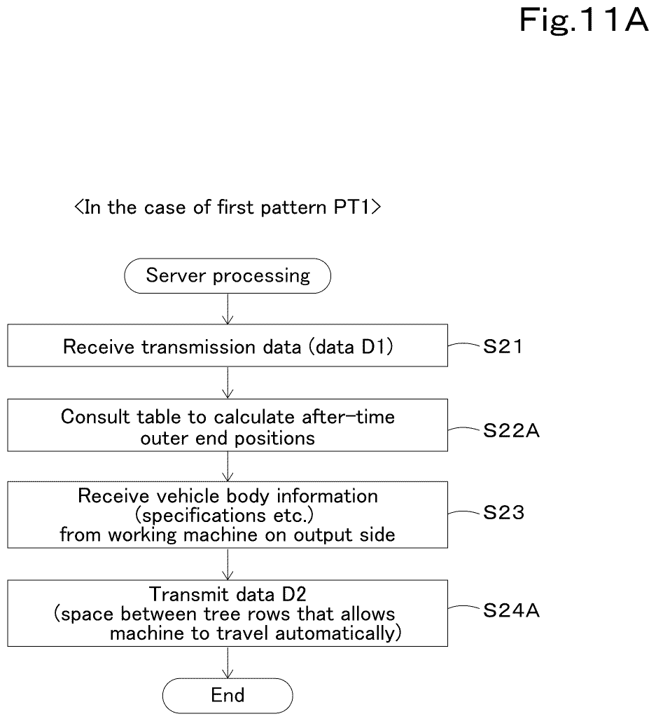

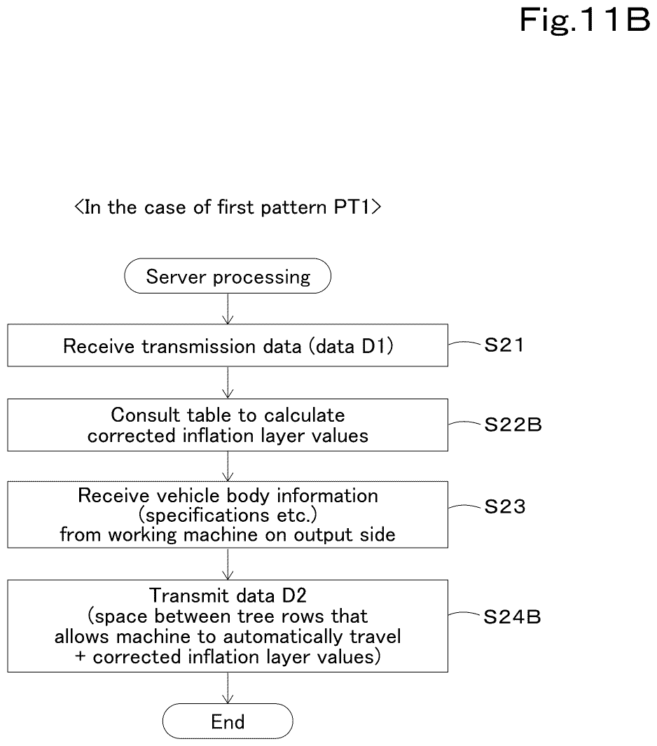

The following first discusses, with reference to FIGS. 10A and 11A, a process performed in the assist system S of the first pattern PT1 according to the first example embodiment. FIG. 10A is a flowchart showing a process performed in the assist system S of the first pattern PT1 according to the first example embodiment. FIG. 11A is a flowchart showing a calculation process performed by the server 50 in FIG. 10A.

As shown in FIG. 10A, the working machine 1 on the input side, i.e., the first working machine 1A, acquires object information (point cloud information about trellises, etc.) indicating tree rows TR (objects) in the surrounding area using the sensor(s) 25, while actually performing work during manual or automatic travel (S11). The controller 20 of the first working machine 1A causes the storing device 21 to store the object information (point cloud information about trellises, etc.), the position information (longitude, latitude) of the first working machine 1A, and the detection time information (for example, date of data acquisition) such that they are associated with each other.

The first working machine 1A (controller 20) acquires the coordinates of outer end positions OL of the tree rows TR (objects) based on the object information (point cloud information about trellises, etc.) (S12). For example, the controller 20 converts the point cloud data in sensor coordinates with the sensor 25 (in particular, the first sensor 25a) as the reference point into point cloud information in absolute coordinates, based on vehicle information (pieces of position information of the first working machine 1A from the start position to the end position). The controller 20 calculates the coordinates of the outer end positions OL of the tree rows TR (objects) in absolute coordinates based on the point cloud information in absolute coordinates.

The first working machine 1A (controller 20) transmits, to the server 50, transmission data (data D1) including position information indicating the coordinates of the outer end positions OL of the tree rows TR (S13). For example, as shown in FIG. 8, the first communicator 29 of the first working machine 1A transmits, to the server 50, transmission data including vehicle information, the type of sensor used, agricultural field location information, the start position and the end position, point cloud information (object information), trellis length, trellis width, trellis spacing, date of data acquisition (detection time information), and/or the like. Note that the controller 53 (calculator 54) of the server 50 may perform the foregoing step S12 performed by the first working machine 1A. That is, the controller 53 (calculator 54) may calculate (obtain) the coordinates of the outer end positions OL of the tree rows TR (objects).

After S13, the server 50 performs the calculation process (S20). Specifically, the server 50 receives transmission data, as shown in FIG. 11A (S21). The calculator 54 consults a preset table indicating the relationship between the detection time, the time-of-use, and the after-time outer end position OL1 to calculate the after-time outer end position OL1 (S22A). For example, at step S22A, the calculator 54 uses the table TB1 shown in FIG. 14, the table TB2 shown in FIG. 15, the growth table TB3 shown in FIG. 16, or the growth table TB4 shown in FIG. 17 to calculate the after-time outer end position OL1.

The following describes the case in which the table TB1 shown in FIG. 14 is used. FIG. 14 shows an example of the table TB1. The table TB1 shown in FIG. 14 is a data table of 12 columns and 12 rows. The twelve cells arranged in the leftmost column show the months (January to December) at which data is acquired (i.e., detection times), and the twelve cells arranged in the uppermost row each show the number of months (referred to as “actual travel month”) passed since the month of data acquisition at the time when the vehicle actually travels (i.e., at the time-of-use). Each cell, which is an intersection of a column and a row, is associated with a value such as “1”, “1.5” or “2”. The after-time outer end positions OL1 are respectively associated with these values. The unit of the value of each cell is, for example, feet. However, the unit of the value of each cell is not limited to feet, and may be, for example, centimeter or the like. FIG. 9C illustrates the after-time outer end positions OL1 of each of the first, fourth and seventh months in the case of using data acquired in winter, in the first example embodiment. For example, the following describes the case where the month of data acquisition is January: in the case where the actual travel month is the first month, the calculator 54 calculates, with respect to the coordinates of an outer end position OL at a distance of “1” from the center of a tree row TR, the after-time outer end position OL1 at the same distance of “1” from the center of the tree row TR (see solid line of the first month in FIG. 9C). In the case where the actual travel month is the fourth month, the calculator 54 calculates, with respect to the coordinates of the outer end position OL at a distance of “1” from the center of the tree row TR, the after-time outer end position OL1 at a distance of “1.5” from the center of the tree row TR (see dot-dash line of the fourth month in FIG. 9C). In the case where the actual travel month is the seventh month, the calculator 54 calculates, with respect to the coordinates of the outer end position OL at a distance of “1” from the center of the tree row TR, the after-time outer end position OL1 at a distance of “2” from the center of the tree row TR (see dashed line of the seventh month in FIG. 9C).

On the other hand, FIG. 9D illustrates the after-time outer end positions OL1 of each of the first, fourth and seventh months in the case of using data acquired in summer in the first example embodiment. In the case where the month of data acquisition is July, and the actual travel month is the first month, the calculator 54 calculates, with respect to the coordinates of an outer end position OL at a distance of “2” from the center of a tree row TR, the after-time outer end position OL1 at the same distance of “2” from the center of the tree row TR (see dashed line of the first month in FIG. 9D). In the case where the actual travel month is the fourth month, the calculator 54 calculates, with respect to the coordinates of the outer end position OL at a distance of “2” from the center of the tree row TR, the after-time outer end position OL1 at a reduced distance of “1.5” from the center of the tree row TR (see dot-dash line of the fourth month in FIG. 9D). In the case where the actual travel month is the seventh month, the calculator 54 calculates, with respect to the coordinates of the outer end position OL at a distance of “2” from the center of the tree row TR, the after-time outer end position OL1 at a reduced distance of “1” from the center of the tree row TR (see solid line of the seventh month in FIG. 9D).

The following describes the case in which the table TB2 shown in FIG. 15 is used. FIG. 15 shows an example of the table TB2. In the table TB2 shown in FIG. 15, the twelve cells arranged in the leftmost column show months (January to December) at which data is acquired (i.e., detection times), and the twelve cells arranged in the uppermost row show months indicating seasons (referred to as “actual travel months”) (i.e., times-of-use). Each cell, which is an intersection of a column and a row, is associated with an after-time outer end position OL1 represented by a value such as “0”, “0.5”, “1”, “1.5” or “2” feet (approximately 0, 15, 30, 45 or 60 cm). FIG. 9E illustrates the after-time outer end positions OL1 of January, April, and July in the case of using data acquired in winter, in the first example embodiment. For example, in the case where the month of data acquisition is January (i.e., winter) and the actual travel month is January (also winter), the calculator 54 calculates, with respect to the coordinates of an outer end position OL at a distance of “1” from the center of a tree row TR, the after-time outer end position OL1 at the same distance of “1” from the center of the tree row TR (see solid line of January in FIG. 9E). In the case where the actual travel month is April (i.e., spring), the calculator 54 calculates, with respect to the coordinates of the outer end position OL at a distance of “1” from the center of the tree row TR, the after-time outer end position OL1 at a distance of “1.5” from the center of the tree row TR (see dot-dash line of April in FIG. 9E). In the case where the actual travel month is July (i.e., summer), the calculator 54 calculates, with respect to the coordinates of the outer end position OL at a distance of “1” from the center of the tree row TR, the after-time outer end position OL1 at a distance of “2” from the center of the tree row TR (see dashed line of July in FIG. 9E).

On the contrary, FIG. 9F illustrates the after-time outer end positions OL1 of January, April, and July in the case of using data acquired in summer, in the first example embodiment. For example, in the case where the month of data acquisition is July and the actual travel month is January (i.e., winter), the calculator 54 calculates, with respect to the coordinates of an outer end position OL at a distance of “1” from the center of a tree row TR, the after-time outer end position OL1 at a reduced distance of “0” from the center of the tree row TR (see solid line of January in FIG. 9F). In the case where the actual travel month is April (i.e., spring), the calculator 54 calculates, with respect to the coordinates of the outer end position OL at a distance of “1” from the center of the tree row TR, the after-time outer end position OL1 at a reduced distance of “0.5” from the center of the tree row TR (see dot-dash line of April in FIG. 9F). In the case where the actual travel month is July (i.e., summer), the calculator 54 calculates, with respect to the coordinates of the outer end position OL at a distance of “1” from the center of the tree row TR, the after-time outer end position OL1 at the same distance of “1” from the center of the tree row TR (see dashed line of July in FIG. 9F).

The following describes the case in which the growth table TB3 shown in FIG. 16 is used. FIG. 16 illustrates an example of the growth table TB3. In the growth table TB3 shown in FIG. 16, the twelve cells arranged in the leftmost column show months (January to December) at which data is acquired (i.e., detection times), and the twelve cells arranged in the uppermost row show actual travel months indicating seasons (i.e., times-of-use). Each cell, which is an intersection of a column and a row, is associated with an after-time outer end position OL1 determined in consideration of the growth phase, represented by a value such as “0”, “0.5”, “1”, “1.5” or “2” feet (approximately 0, 15, 30, 45 or 60 cm). For example, in the case where the month of data acquisition is December to February (i.e., pruning period) and the actual travel month is in the pruning period (e.g., December to February), the calculator 54 calculates, with respect to the coordinates of an outer end position OL at a distance of “1” from the center of a tree row TR, the after-time outer end position OL1 at the same distance of “1” from the center of the tree row TR. In the case where the actual travel month is in the growing period (e.g., March to July), the calculator 54 calculates, with respect to the coordinates of the outer end position OL at a distance of “1” from the center of the tree row TR, the after-time outer end position OL1 at a distance of “1.5” from the center of the tree row TR. In the case where the actual travel month is in the harvesting period (e.g., August to October), the calculator 54 calculates, with respect to the coordinates of the outer end position OL at a distance of “1” from the center of the tree row TR, the after-time outer end position OL1 at a distance of “2” from the center of the tree row TR. In the case where the actual travel month is in the withering period (e.g., November), the calculator 54 calculates, with respect to the coordinates of the outer end position OL at a distance of “1” from the center of the tree row TR, the after-time outer end position OL1 at a distance of “1.5” from the center of the tree row TR.

On the contrary, in the case where the month of data acquisition is August to October (i.e., harvesting period) and the actual travel month is in the pruning period (e.g., December to February), the calculator 54 calculates, with respect to the coordinates of an outer end position OL at a distance of “1” from the center of a tree row TR, the after-time outer end position OL1 at a reduced distance of “0” from the center of the tree row TR. In the case where the actual travel month is in the growing period (e.g., March to July), the calculator 54 calculates, with respect to the coordinates of the outer end position OL at a distance of “1” from the center of the tree row TR, the after-time outer end position OL1 at a reduced distance of “0.5” from the center of the tree row TR. In the case where the actual travel month is in the harvesting period (e.g., August to October), the calculator 54 calculates, with respect to the coordinates of the outer end position OL at a distance of “1” from the center of the tree row TR, the after-time outer end position OL1 at a distance of “1” from the center of the tree row TR. In the case where the actual travel month is in the withering period (e.g., November), the calculator 54 calculates, with respect to the coordinates of the outer end position OL at a distance of “1” from the center of the tree row TR, the after-time outer end position OL1 at a distance of “0.5” from the center of the tree row TR.

The following describes the case using the growth table TB4 shown in FIG. 17. FIG. 17 illustrates an example of the growth table TB4 for the Southern Hemisphere. In contrast to the growth table TB3 for the Northern Hemisphere shown in FIG. 16, FIG. 17 shows a growth table TB4 for the Southern Hemisphere. The calculator 54 is configured or programmed to, if determining that the agricultural field is located in the Southern Hemisphere based on the position information of the first mobile body VA, determine to use the growth table TB4 shown in FIG. 17.

Referring back to FIG. 11A, the server 50 receives vehicle body information (specifications and/or the like) from the working machine 1 on the output side of the server 50 (the first working machine 1A in this example) (S23). The server 50 (controller 53) then determines that the type of sensor used included in the received vehicle body information is LiDAR, i.e., determines that the working machine 1 on the output side of the server 50 (first working machine 1A) includes sensor(s) 25, and transmits data D2 (for example, a space W between tree rows that allows the working machine to automatically travel) to the working machine 1 on the output side of the server 50 (first working machine 1A) (S24A). That is, the second communicator 51 transmits after-time outer end positions OL1 (for example, the space W between tree rows that allows the working machine to automatically travel). Furthermore, although the server 50 determines that it is not necessary to generate a route for the working machine 1 on the output side of the server 50 (first working machine 1A), in the case where the server 50 receives a request for route generation from the working machine 1 on the output side of the server 50 (first working machine 1A), the server 50 may generate a route based on the after-time outer end positions OL1 and based on the vehicle body information of the first working machine 1A, and may transmit the generated route. Note that the generated route can be categorized into “Global path” or “Local path”. The “Global path” is a comprehensive route (path), and can be generated by the server 50. Even in the case where the vehicle includes sensor(s) (i.e., the first working machine 1A), the vehicle may receive the “Global path” from the server 50 and use it. The “Local path” is a local route (path) and is to be changed depending on the situation such as obstacles and slopes. Thus, a vehicle including sensor(s) (first working machine 1A) has the function to generate a “Local path”.

As shown in FIG. 10A, the working machine 1 on the output side of the server 50 (first working machine 1A) acquires the data D2 (for example, the space W between tree rows that allows the working machine to automatically travel) (S31A). That is, the first communicator 29 receives the after-time outer end positions OL1 (for example, the space W between tree rows W that allows the working machine to automatically travel). The working machine 1 on the output side of the server 50 (first working machine 1A) generates a route (path PS) (S32). The working machine 1 on the output side of the server 50 (first working machine 1A) performs automatic operation based on the data D2 (after-time outer end positions OL1, or the space W between tree rows W that allows the working machine to automatically travel) received from the server 50 and based on the route (path PS) generated thereby (S33).

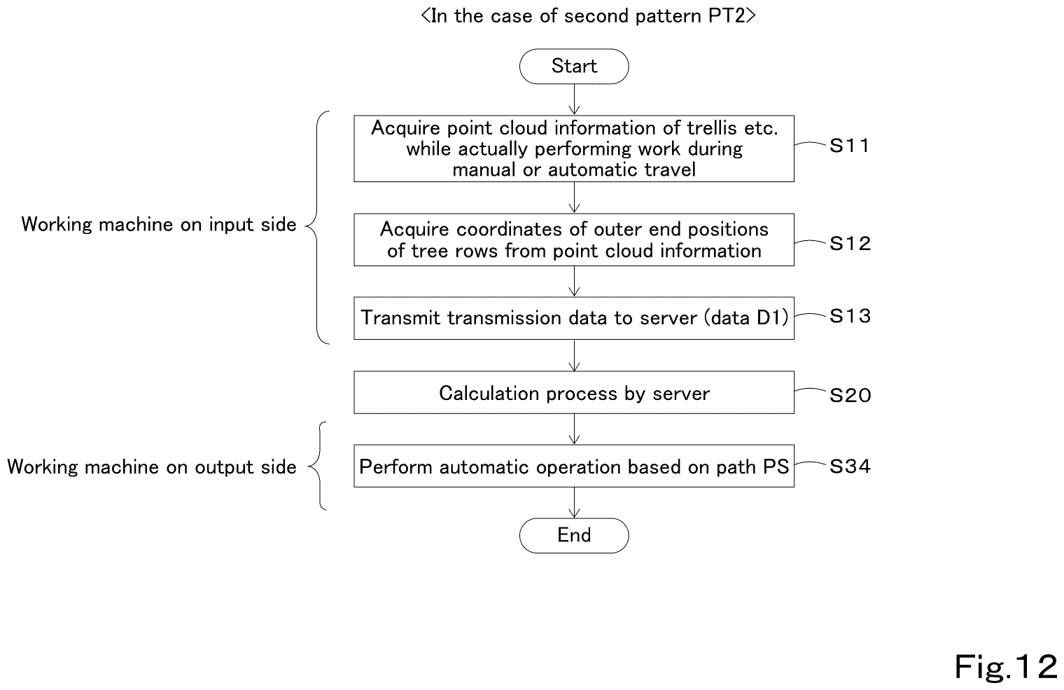

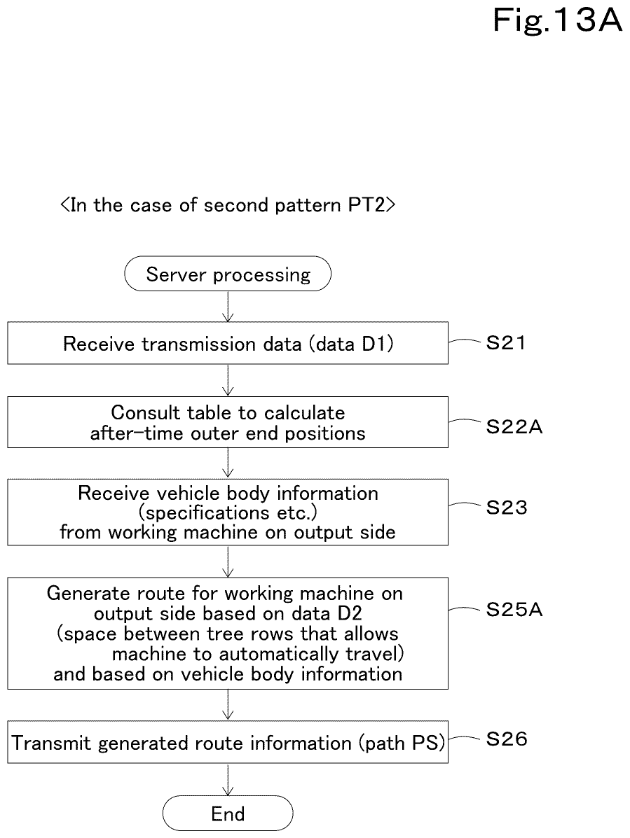

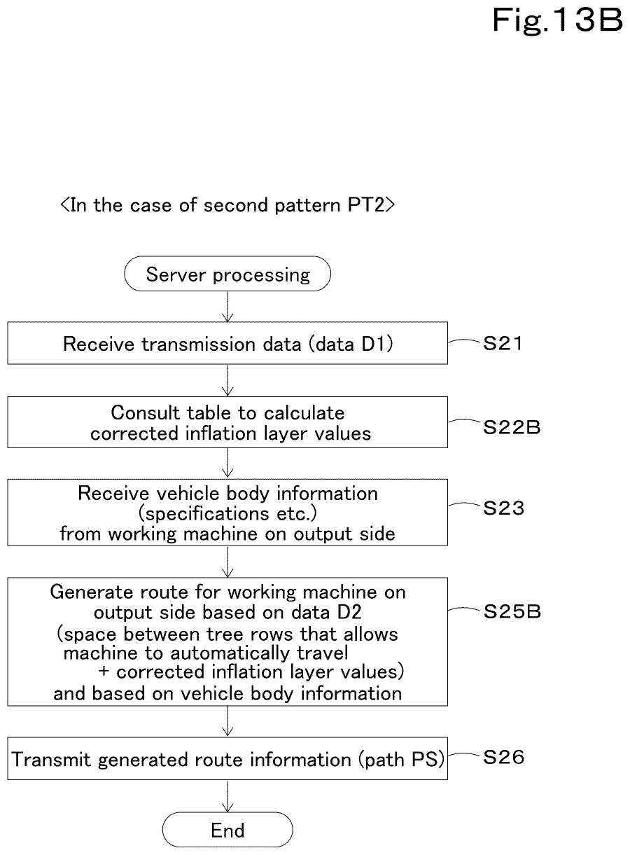

The following describes a process performed in the assist system S of the second pattern PT2 according to the first example embodiment, with reference to FIGS. 12 and 13A. That is, the working machine 1 on the output side of the server 50 is a second working machine 1B which does not include sensors 25. FIG. 12 is a flowchart showing the process performed in the assist system S of the second pattern PT2 according to the first and second example embodiments. FIG. 13A is a flowchart showing a process performed by the server 50 shown in FIG. 12 according to the first example embodiment. Note that only the steps in FIGS. 12 and 13A that differ from those in FIGS. 10A and 11A are described in detail, and the description of the same steps as those in FIGS. 10A and 11A is omitted here.

Steps S11 to S13 shown in FIG. 12 are the same as steps S11 to S13 shown in the foregoing FIG. 10A. After S13, the server 50 performs a calculation process (S20). Specifically, as shown in FIG. 13A, the server 50 performs steps S21, S22A, S23, S25A and S26. Since steps S25A and S26 shown in FIG. 13A are not in the foregoing FIG. 11A, steps S25A and S26 will now be described.

As shown in FIG. 13A, after S23, the server 50 (controller 53) determines that the type of sensor used included in the received vehicle information is not LiDAR, i.e., determines that the working machine 1 on the output side of the server 50 (second working machine 1B) does not include sensors 25, and generates a route for the working machine 1 on the output side of the server 50 (second working machine 1B) (S25A). The server 50 (controller 53) generates a route (path PS) for the working machine 1 on the output side (second working machine 1B) based on data D2 (after-time outer end positions OL1, or the space W between tree rows that allows the working machine to automatically travel) and based on the vehicle body information. The server 50 transmits the generated route to the working machine 1 on the output side of the server 50 (second working machine 1B) (S26). At S26, the server 50 may transmit the after-time outer end positions OL1 (for example, the space W between tree rows that allows the working machine to automatically travel) together with the generated route.

The working machine 1 on the output side of the server 50 (second working machine 1B) performs automatic operation based on the route received from the server 50 (S34). The working machine 1 on the output side of the server 50 (second working machine 1B) may perform automatic operation based on the after-time outer end positions OL1 (for example, the space W between tree rows that allows the working machine to automatically travel) and based on the route received from the server 50.

### Second Example Embodiment

As shown in FIG. 9A, the assist system S according to the first example embodiment obtains an after-time outer end position OL1 (changed end position of grape vines) by changing, according to the time-of-use during which the second mobile body VB is to be used, an outer end position OL of objects (end position of grape vines) detected by the first mobile body VA. On the contrary, as shown in FIG. 9B, an assist system S according to a second example embodiment obtains an after-time outer end position OL1 by defining an off-limits area IL (inflation layer) extending outward from the outer end position OL of object(s) (end position of grape vines) detected by the first mobile body VA, and using, as the after-time outer end position OL1, the outer end position of the off-limits area IL with a size changed according to the time-of-use during which the second mobile body VB is to be used. FIG. 9B illustrates the after-time outer end positions OL1 obtained by expanding or reducing the off-limits areas IL depending on the season, in the second example embodiment.

The calculator 54 defines an off-limits area IL (inflation layer) having a predetermined dimension D extending from an outer end position OL of objects (end position of grape vines) outward as shown in FIG. 9B, based on the object information (for example, point cloud information) detected by the sensor(s) 25 and based on the detection time information indicating the detection time (for example, date of data acquisition), and uses the outer end position of the off-limits area IL as the after-time outer end position OL1. The second communicator 51 transmits the outer end position OL of the objects and the off-limits area IL to the second mobile body VB (first working machine 1A or second working machine 1B).

The calculator 54 calculates the after-time outer end position OL1 by changing the predetermined dimension D of the off-limits area IL based on elapsed time information about the time from the detection time to the time-of-use.

For example, the calculator 54 may calculate an inflation layer value (i.e., a predetermined dimension D) by consulting a preset table (any of the tables TB1 and TB2 shown in FIGS. 14 and 15, and tables TB3 and TB4 shown in FIGS. 16 and 17) indicating the relationship between the detection time, the time-of-use, and an inflation layer value (i.e., inflation layer value is equal to the predetermined dimension D of the off-limits area IL), and use the outer end position of the off-limits area IL having the calculated predetermined dimension D as the after-time outer end position OL1. In the second example embodiment, it is only necessary to interpret the tables TB1 and TB2 shown in FIGS. 14 and 15 and the growth tables TB3 and TB4 shown in FIGS. 16 and 17 such that their cells are associated with respective inflation layer values (i.e., respective predetermined dimensions D).

In the case where the table TB1 shown in FIG. 14 is used in the second example embodiment, each of the cells of the table TB1 is associated with an inflation layer value represented by “1”, “1.5” or “2” feet. FIG. 9G illustrates the after-time outer end positions OL1 of each of the first, fourth and seventh months in the case of using data acquired in winter in the second example embodiment. For example, in the case where the month of data acquisition is January and the actual travel month is the first month, the calculator 54 calculates the same inflation layer value of “1” as the inflation layer value in January of “1” (refer to solid line of the first month in FIG. 9G). In the case where the actual travel month is the fourth month, the calculator 54 calculates an inflation layer value of “1.5” with respect to the inflation layer value in January of “1” (see dot-dash line of the fourth month in FIG. 9G). In the case where the actual travel month is July, the calculator 54 calculates an inflation layer value of “2” with respect to the inflation layer value in January of “1” (see dashed line of the seventh month in FIG. 9G).

On the other hand, FIG. 9H illustrates the after-time outer end positions OL1 of each of the first, fourth and seventh months in the case of using data acquired in summer in the second example embodiment. In the case where the actual month of data acquisition is July and the actual travel month is the first month, the calculator 54 calculates an inflation layer value of “2” with respect to the inflation layer value in July of “2” (see dashed line of the first month in FIG. 9H). In the case where the actual travel month is the fourth month, the calculator 54 calculates a reduced inflation layer value of “1.5” with respect to the inflation layer value in July of “2” (see dot-dash line of the fourth month in FIG. 9H). In the case where the actual travel month is the seventh month, the calculator 54 calculates a reduced inflation layer value of “1” with respect to the inflation layer value in July of “2” (see solid line of the seventh month in FIG. 9H).

Next, in the case where the table TB2 shown in FIG. 15 is used in the second example embodiment, each of the cells of the table TB2 is associated with an inflation layer value represented by “0”, “0.5”, “1”, “1.5” or “2” feet. FIG. 9I illustrates the after-time outer end positions OL1 of January, April and July in the case of using data acquired in winter in the second example embodiment. For example, in the case where the month of data acquisition is January (i.e., winter) and the actual travel month is January (also winter), the calculator 54 calculates the same inflation layer value of “1” as the inflation layer value of “1” in January as (see solid line of January in FIG. 9I). In the case where the actual travel month is April (i.e., spring), the calculator 54 calculates an inflation layer value of “1.5” with respect to the inflation layer value in January of “1” (see dot-dash line of April in FIG. 9I). In the case where the actual travel month is July (i.e., summer), the calculator 54 calculates an inflation layer value of “2” with respect to the inflation layer value in January of “1” (see dashed line of July in FIG. 9I).

On the other hand, FIG. 9J illustrates the after-time outer end positions OL1 of January, April and July in the case of using data acquired in summer in the second example embodiment. In the case where the month of data acquisition is July and the actual travel month is January (i.e., winter), the calculator 54 calculates a reduced inflation layer value of “0” with respect to the inflation layer value in July of “1” (see solid line of January in FIG. 9J, it is noted here that the inflation layer having a certain dimension D is ensured). In the case where the actual travel month is April (i.e., spring), the calculator 54 calculates a reduced inflation layer value of “0.5” with respect to the inflation layer value in July of “1” (see dot-dash line of April in FIG. 9J). In the case where the actual travel month is July (i.e., summer), the calculator 54 calculates the same inflation layer value of “1” as the inflation layer value in July of “1” (see dashed line of July in FIG. 9J).

The server 50 may include an estimator 55 configured or programmed to identify whether object(s) is/are plant(s) and, in a case that the object is a plant, estimate the type and the growth state of the plant. The calculator 54 is configured or programmed to calculate the after-time outer end position OL1 by changing the predetermined dimension D of the off-limits area IL based on the detection time and the current growth state of the plant.

Also in the case where the growth table TB3 shown in FIG. 16 or the growth table TB4 shown in FIG. 17 is used in the second example embodiment, it is only necessary that the values in the cells be interpreted as inflation layer values as discussed in the above description, and therefore the description thereof is omitted.

The following discusses a process performed in the assist system S of the first pattern PT1 according to the second example embodiment, with reference to FIGS. 10B and 11B. FIG. 10B is a flowchart showing the process performed in the assist system S of the first pattern PT1 according to the second example embodiment. FIG. 11B is a flowchart showing a calculation process performed by the server 50 shown in FIG. 10B.

Since steps S11 to S13 shown in FIG. 10B are the same as steps S11 to S13 shown in FIG. 10A, the description thereof is omitted here. After S13, the server 50 performs a calculation process (S20). Specifically, as shown in FIG. 11B, the server 50 performs the steps S21, S22B, S23 and S24B. Since steps S22B and S24B shown in FIG. 11B differ from steps S22A and S24A shown the foregoing FIG. 11A, steps S22B and S24B will now be described.

As shown in FIG. 11B, the calculator 54 calculates an inflation layer value (i.e., a predetermined dimension D) by consulting a preset table indicating the corresponding relationship between the detection time, the time-of-use, and the inflation layer value (which is the predetermined dimension D of the off-limits area IL), and uses the outer end position of the off-limits area IL having the calculated predetermined dimension D as the after-time outer end position OL1 (S22B). For example, at S22B, the calculator 54 calculates an inflation layer value (i.e., a predetermined dimension D) using the table TB1 shown in FIG. 14, the table TB2 shown in FIG. 15, the growth table TB3 shown in FIG. 16, or the growth table TB4 shown in FIG. 17.

As shown in FIG. 11B, after S23, the server 50 (controller 53) determines that the type of sensor used included in the received vehicle body information is LiDAR, i.e., determines that the working machine 1 on the output side of the server 50 (first working machine 1A) includes sensor(s) 25, and transmits data D2 (for example, the space W between tree rows that allows the working machine to travel automatically and the corrected (calculated) inflation layer value) to the working machine 1 on the output side of the server 50 (first working machine 1A) (S24B).

As shown in FIG. 10B, the working machine 1 on the output side of the server 50 (first working machine 1A) acquires the data D2 (for example, the space W between tree rows that allows the working machine to travel automatically and the corrected (calculated) inflation layer value) (S31B). That is, the first communicator 29 receives the after-time outer end positions OL1 (for example, the space W between tree rows that allows the working machine to automatically travel and the corrected (calculated) inflation layer value). The working machine 1 on the output side of the server 50 (first working machine 1A) generates a route (path PS) (S32). The working machine 1 on the output side of the server 50 (first working machine 1A) performs automatic operation based on the data D2 (after-time outer end positions OL1, or the space W between tree rows that allows the working machine to automatically travel) received from the server 50 and based on the route (path PS) generated thereby (S33).

The following describes a process performed in the assist system S of the second pattern PT2 in the second example embodiment, with reference to FIGS. 12 and 13B. That is, the working machine 1 on the output side of the server 50 is a second working machine 1B which does not include sensors 25. FIG. 13B is a flowchart showing a calculation process performed by the server 50 shown in FIG. 12 in the second example embodiment.

Steps S11 to S13 shown in FIG. 12 are the same as steps S11 to S13 shown in the foregoing FIG. 10A. After S13, the server 50 performs a calculation process (S20). Specifically, as shown in FIG. 13B, the server 50 performs steps S21, S22B, S23, S25B and S26. Since S22B and S25B shown in FIG. 13A are not in the foregoing FIG. 11B, steps S25B and S26 will now be described.

As shown in FIG. 13B, after S23, the server 50 (controller 53) determines that the type of sensor used included in the received vehicle information is not LiDAR, i.e., determines that the working machine 1 on the output side of the server 50 (second working machine 1B) does not include sensors 25, and generates a route for the working machine 1 on the output side of the server 50 (second working machine 1B) (S25B). The server 50 (controller 53) generates a route (path PS) for the working machine 1 on the output side (second working machine 1B) based on the data D2 (after-time outer end positions OL1, i.e., the space W between tree rows that allows the working machine to automatically travel and the corrected (calculated) inflation layer value) and based on the vehicle body information. The server 50 transmits the generated route to the working machine 1 on the output side of the server 50 (second working machine 1B) (S26). At S26, the server 50 may transmit the after-time outer end positions OL1 (for example, the space W between tree rows that allows the working machine to automatically travel) together with the generated route.

The working machine 1 on the output side of the server 50 (second working machine 1B) performs automatic operation based on the route received from the server 50 (S34). The working machine 1 on the output side of the server 50 (second working machine 1B) may perform automatic operation based on the after-time outer end positions OL1 (for example, the space W between tree rows that allows the working machine to automatically travel and the corrected (calculated) inflation layer value) and based on the route received from the server 50.

### Third Example Embodiment

As shown in FIG. 9B, the assist system S according to the second example embodiment changes the predetermined dimension D of the defined off-limits area IL (inflation layer) extending from the outer end position OL of objects (end position of grape vines) outward, according to the time-of-use of the second mobile body VB. In contrast, an assist system S according to a third example embodiment uses a fixed predetermined dimension D of the off-limits area IL (which is variable in the second example embodiment), and changes the outer end position OL of objects (end position of grape vines) according to the time-of-use of the second mobile body VB as with the case of the first example embodiment, to use the outer end position of such an off-limits area IL as the after-time outer end position OL1.

For example, the calculator 54 of the server 50 defines a fixed off-limits area IL (inflation layer) having a fixed predetermined dimension D (for example, fixed at 1 ft.) extending from the outer end position OL of objects outward. The calculator 54 changes the outer end position OL of the objects at the detection time, based on elapsed time information about the time from the detection time to the time-of-use, to obtain the after-time outer end position OL1 which is the outer end position of the off-limits area IL (having a fixed dimension) extending outward from the outer end position OL. Then, the second communicator 51 transmits the outer end position OL of the objects and the off-limits area IL to the first mobile body VA (first working machine 1A) or the second mobile body VB (second working machine 1B).

In such a case, the calculator 54 of the server 50 is configured or programmed to use the off-limits area IL having a fixed predetermined dimension D, and change the outer end position OL of the objects at the detection time to a position suitable for the time-of-use during which the first mobile body VA (first working machine 1A) or the second mobile body VB (second working machine 1B) is used. This makes it possible to appropriately calculate the after-time outer end position OL1 using the off-limits area IL which is a buffer area of a fixed size.

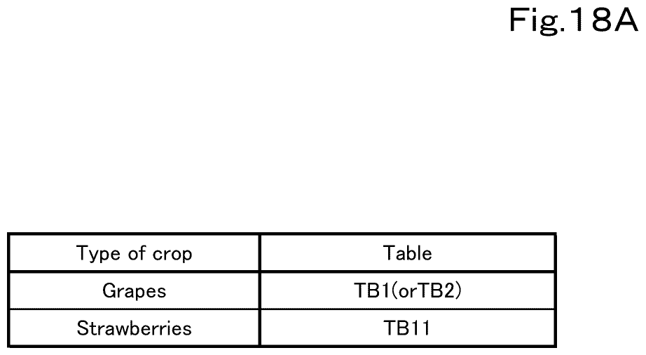

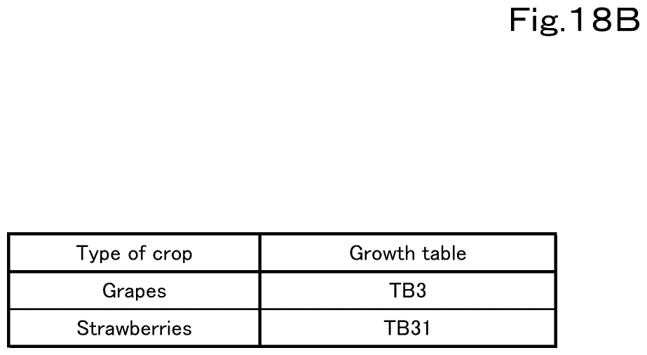

Note that the estimator 55 may be configured or programmed to, in the case where the object(s) is/are crop(s), identify the type of the crop. For example, the estimator 55 is configured or programmed to identify (determine) the type of crop (for example, fruits such as grapes or strawberries, vegetables such as potatoes, asparagus, or cabbages, or the like) using image matching between an image of the crop taken by the imager 26 and images of crops stored in advance in the storing device 52. FIG. 18A illustrates examples of a table corresponding to the type of crop. As shown in FIG. 18A, the server 50 includes a plurality of tables TB1 and TB11 corresponding to the types of crops. The server 50 consults the table TB1 or TB11 corresponding to the type of crop shown in FIG. 18A to calculate the after-time outer end position OL1. For example, in the case where the estimator 55 determines that the type of the crop is grapes, the server 50, as shown in FIG. 18A, selects the table TB1 corresponding to grapes (or may be the table TB2), and consults the table TB1 shown in FIG. 14 (or the table TB2) to calculate the after-time outer end position OL1. On the contrary, in the case where the estimator 55 determines that the type of the crop is strawberries, the server 50, as shown in FIG. 18A, selects the table TB11 corresponding to strawberries, and consults the table TB11 to calculate the after-time outer end position OL1.

The estimator 55 is configured or programmed to, in the case where the object(s) are/is crop(s), identifies the type of the crop. FIG. 18B illustrates examples of a table corresponding to the type of the crop. As shown in FIG. 18B, the server 50 includes a plurality of growth tables TB3 and TB31 corresponding to respective types of crops. The server 50 consults the growth table TB3 or TB31 corresponding to the type of the crop as shown in FIG. 18B to calculate the after-time outer end position OL1. For example, in the case where the estimator 55 determines that the type of the crop is grapes, the server 50, as shown in FIG. 18B, selects the growth table TB3 corresponding to grapes, and consults the growth table TB3 shown in FIG. 16 to calculate the after-time outer end position OL1. On the contrary, in the case where the estimator 55 determines that the type of the crop is strawberries, the server 50, as shown in FIG. 18B, selects the growth table TB31 corresponding to strawberries, and consults the growth table TB31 to calculate the after-time outer end position OL1.

The following describes main characteristic features of assist systems S according to example embodiments described so far and effects achieved by the assist systems S.

(Item A1) An assist system S including a first mobile body VA including a sensor 25 to detect objects in a surrounding area of the first mobile body VA, and a first communicator 29 configured or programmed to transmit object information about an object detected by the sensor 25 and detection time information indicating a detection time at which the object is detected, and a server 50 including a calculator 54 configured or programmed to calculate, based on the object information and the detection time information from the first mobile body VA, an after-time outer end position OL1 of the object in a time-of-use during which the object information is to be used, by measuring a time from the detection time, and a second communicator 51 configured or programmed to transmit the after-time outer end position OL1 to the first mobile body VA or to a second mobile body VB.

With this configuration, the server 50 is able to correct the outer end position OL of the object detected at the first mobile body VA based on the time-of-use which differs from the detection time to obtain the after-time outer end position OL1, and provide the after-time outer end position OL1 to the first mobile body VA or to the second mobile body VB. Thus, the first mobile body VA or the second mobile body VB is able to travel using the after-time outer end position OL1 of the object for the time-of-use. Therefore, with the assist system S, it is possible to make effective use of the object information in a different time of year from the detection time.

(Item A2) The assist system S according to item A1, wherein the calculator 54 is configured or programmed to calculate the after-time outer end position OL1 by changing an outer end position OL of the object at the detection time, based on elapsed time information about a time from the detection time to the time-of-use.

With this configuration, since the outer end position OL of the object at the detection time is changed based on the elapsed time information about the time from the detection time to the time-of-use (for example, current temporal information such as the date, month, season), it is possible to appropriately calculate the after-time outer end position OL1.

(Item A3) The assist system S according to item A2, wherein the calculator 54 is configured or programmed to consult a preset table indicating a relationship between the detection time, the time-of-use, and the after-time outer end position OL1 to calculate the after-time outer end position OL1.

With this configuration, since the after-time outer end position OL1 is determined with reference to a table, it is possible to easily and quickly determine the after-time outer end position OL1.

(Item A4) The assist system S according to item A1, wherein the server 50 includes an estimator 55 configured or programmed to identify whether the object is a plant and, in a case that the object is a plant, estimate a type and a growth state of the plant, and the calculator 54 is configured or programmed to calculate the after-time outer end position OL1 by changing an outer end position OL of the object at the detection time based on a current growth state of the plant.

With this configuration, in the case where the object is a plant, the after-time outer end position OL1 of the plant is calculated according to the growth state of the plant, and therefore it is possible to appropriately calculate the after-time outer end position OL1 of the plant. Thus, when the second mobile body VB travels during the time-of-use which is different in time from the detection time, it is possible to eliminate or reduce the likelihood that the second mobile body VB will contact plants which change their outer shape as they grow.

(Item A5) The assist system S according to item A4, wherein the calculator 54 is configured or programmed to consult a preset table TB1, TB2 indicating a relationship between the detection time, the time-of-use, and the after-time outer end position OL1 to calculate the after-time outer end position OL1.

With this configuration, since the after-time outer end position OL1 of the plant is determined with reference to a table, it is possible to easily and quickly determine the after-time outer end position OL1 of the plant.

(Item A6) The assist system S according to item A4, wherein the calculator 54 is configured or programmed to consult a preset growth table TB3 indicating a relationship between the detection time, the current growth state, and the after-time outer end position OL1 to calculate the after-time outer end position OL1.

With this configuration, since the after-time outer end position OL1 of the plant that corresponds to the growth state is determined with reference to the growth table TB3, it is possible to determine the after-time outer end position OL1 of the plant more accurately.

(Item A7) The assist system S according to item A4, wherein the estimator 55 is configured or programmed to identify whether the object is a fruit tree FT, and the calculator 54 is configured or programmed to, in a case that the object is a fruit tree FT, calculate the after-time outer end position OL1 of a tree row TR that is a line connecting, in a predetermined direction Y, a plurality of the outer end positions OL of a plurality of the fruit trees FT arranged at one or more intervals in the predetermined direction Y.

With this configuration, it is possible to calculate the after-time outer end position OL1 of a tree row TR of fruit trees FT. Thus, when the second mobile body VB travels during the time-of-use which is different in time from the detection time, it is possible to eliminate or reduce the likelihood that the second mobile body VB will contact the tree rows TR which change their outer shape as they grow.

(Item A8) The assist system S according to item A3, further including an estimator 55 configured or programmed to, in a case that the object is a crop, identify a type of the crop, wherein the server 50 includes a plurality of the tables TB1, TB2, and TB11 corresponding to respective types of a plurality of the crops, and is configured or programmed to consult one of the plurality of tables that corresponds to the type of the crop to calculate the after-time outer end position OL1.

With this configuration, since the after-time outer end position OL1 is determined with reference to the table TB1, TB2, or TB11 that corresponds to the type of the crop, it is possible to appropriately determine the after-time outer end position OL1 of the crop based on the type of the crop.

(Item A9) The assist system S according to item A6, wherein the estimator 55 is configured or programmed to, in a case that the object is a crop, identify a type of the crop, and the server 50 includes a plurality of the growth tables TB3, TB31 corresponding to respective types of a plurality of the crops, and is configured or programmed to consult one of the plurality of growth tables that corresponds to the type of the crop to calculate the after-time outer end position OL1.

With this configuration, since the after-time outer end position OL1 corresponding to the growth state is determined with reference to the growth table TB3 or TB31 that corresponds to the type of the crop, it is possible to determine the after-time outer end position OL1 of the crop based on the type of the crop more accurately.

(Item A10) The assist system S according to any one of items A1 to A9, wherein the second mobile body VB includes a position detector 27 to detect a position thereof but does not include the sensor 25, the server 50 includes a route generator 56 configured or programmed to generate a route to be traveled by the second mobile body VB based on acquired position information of the second mobile body VB and based on the after-time outer end position OL1 calculated by the calculator 54, and the second communicator 51 is configured or programmed to transmit the route to be traveled by the second mobile body VB to the second mobile body VB.

With this configuration, even a second mobile body VB including no sensors 25 is able to not only travel such that the position thereof is located on the travel route generated by the server 50 but also travel using the after-time outer end position OL1 of the object for the time-of-use. Thus, the second mobile body VB is able to travel without approaching the after-time outer end position OL1, and is able to operate as if it had a configuration including a sensor 25.

(Item A11) The assist system S according to item A1, wherein the calculator 54 is configured or programmed to define an off-limits area IL having a predetermined dimension D extending from an outer end position OL of the object outward based on the object information and the detection time information, and use an outer end position of the off-limits area IL as the after-time outer end position OL1, and the second communicator 51 is configured or programmed to transmit the outer end position OL of the object and the off-limits area IL to the first mobile body VA or to the second mobile body VB.

With this configuration, the predetermined dimension D of the off-limits area IL (inflation layer) extending from the outer end position OL of the object outward can be made suitable for the time-of-use of the first mobile body VA or the second mobile body VB. Thus, the off-limits area IL can be set as a buffer area of an appropriate size. Furthermore, the first mobile body VA or the second mobile body VB is able to travel using the after-time outer end position OL1 (i.e., a variable outer end position of the off-limits area IL extending from the outer end position OL outward) of the object for the time-of-use.

(Item A12) The assist system S according to item A11, wherein the calculator 54 is configured or programmed to calculate the after-time outer end position OL1 by changing the predetermined dimension D of the off-limits area IL based on elapsed time information about a time from the detection time to the time-of-use.

With this configuration, since the after-time outer end position OL1 is calculated by changing the predetermined dimension D of the off-limits area IL (inflation layer), it is possible to reduce the calculation load compared to when the after-time outer end position OL1 is calculated by changing the outer end position OL of the object at the detection time.

(Item A13) The assist system S according to item A11, wherein the server 50 includes an estimator 55 configured or programmed to identify whether the object is a plant and, in a case that the object is a plant, estimate a type and a growth state of the plant, and the calculator 54 is configured or programmed to calculate the after-time outer end position OL1 by changing the predetermined dimension D of the off-limits area IL based on the detection time and a current growth state of the plant.

With this configuration, the predetermined dimension D of the off-limits area IL can be changed to a dimension suitable for the growth state of the plant. Thus, the off-limits area IL can be set as a buffer area of a size corresponding to the growth state of the plant.

(Item A14) The assist system S according to item A11, wherein the second mobile body VB includes a position detector 27 to detect a position thereof but does not include the sensor 25, the server 50 includes a route generator 56 configured or programmed to generate a route to be traveled by the second mobile body VB based on acquired position information of the second mobile body VB and based on the outer end position OL of the object calculated by the calculator 54 and the off-limits area IL, and the second communicator 51 is configured or programmed to transmit the route to be traveled by the second mobile body VB to the second mobile body VB.

With this configuration, even a second mobile body VB including no sensors 25 is able to not only travel such that the position thereof is located on the travel route generated by the server 50 but also travel using the after-time outer end position OL1 of the object for the time-of-use. Thus, the second mobile body VB is able to travel without approaching the after-time outer end position OL1 (i.e., a variable outer end position of the off-limits area IL extending from the outer end position OL outward), and is able to operate as if it had a configuration including a sensor 25.

(Item A15) The assist system S according to item A2, wherein the calculator 54 is configured or programmed to define a fixed off-limits area IL having a predetermined dimension D extending from the outer end position OL of the object outward, and use an outer end position of the off-limits area IL as the after-time outer end position OL1, and the second communicator 51 is configured or programmed to transmit the outer end position OL of the object and the off-limits area IL to the first mobile body VA or to the second mobile body VB.

With this configuration, the off-limits area IL (inflation layer) includes a fixed predetermined dimension D, and the outer end position OL of the object at the detection time is changed to a position suitable for the time-of-use of the first mobile body VA or the second mobile body VB. Thus, it is possible to appropriately calculate the after-time outer end position OL1 using the off-limits area IL which is a buffer area of a fixed size.

Note that, although the detector in the above-described example embodiments is a sensor 25, the detector may be an imager 26 and/or the like.

In example embodiments described so far, the second working machine 1B may include sensor(s) 25. In such a case, the second working machine 1B uses after-time outer edge information received from the server 50 as “prior information”. With this, it is possible to reduce the cost for calculation of point cloud information by the sensor(s) 25 included in (e.g., sensor(s) provided in or on) the second working machine 1B. Alternatively, the second working machine 1B may use the after-time outer edge information received from the server 50 as “complementary information”. In such a case, even when the sensor(s) 25 included in the second working machine 1B is/are low in accuracy (for example, in the case of a vehicle including a sensor which can acquire point cloud information only at low precision (a low-cost sensor)), it is possible for the working machine to travel safely between tree rows.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An assist system comprising:
a first mobile body including:
a detector to detect objects in a surrounding area of the first mobile body; and
a first communicator configured or programmed to transmit object information about an object detected by the detector and detection time information indicating a detection time at which the object is detected; and
a server including:
a calculator configured or programmed to calculate, based on the object information and the detection time information from the first mobile body, an after-time outer end position of the object in a time-of-use during which the object information is to be used, by measuring a time from the detection time; and
a second communicator configured or programmed to transmit the after-time outer end position to the first mobile body or to a second mobile body.

2. The assist system according to claim 1, wherein the calculator is configured or programmed to calculate the after-time outer end position by changing an outer end position of the object at the detection time, based on elapsed time information about a time from the detection time to the time-of-use.

3. The assist system according to claim 2, wherein the calculator is configured or programmed to consult a preset table indicating a relationship between the detection time, the time-of-use, and the after-time outer end position to calculate the after-time outer end position.

4. The assist system according to claim 1, wherein
the server includes an estimator configured or programmed to identify whether the object is a plant and, in a case that the object is a plant, estimate a type and a growth state of the plant; and
the calculator is configured or programmed to calculate the after-time outer end position by changing an outer end position of the object at the detection time based on a current growth state of the plant.

5. The assist system according to claim 4, wherein the calculator is configured or programmed to consult a preset table indicating a relationship between the detection time, the time-of-use, and the after-time outer end position to calculate the after-time outer end position.

6. The assist system according to claim 4, wherein the calculator is configured or programmed to consult a preset growth table indicating a relationship between the detection time, the current growth state, and the after-time outer end position to calculate the after-time outer end position.

7. The assist system according to claim 4, wherein
the estimator is configured or programmed to identify whether the object is a fruit tree; and
the calculator is configured or programmed to, in a case that the object is a fruit tree, calculate the after-time outer end position of a tree row that is a line connecting, in a predetermined direction, a plurality of outer end positions of a plurality of the fruit trees arranged at one or more intervals in the predetermined direction.

8. The assist system according to claim 3, further comprising an estimator configured or programmed to, in a case that the object is a crop, identify a type of the crop; wherein
the server includes a plurality of the tables corresponding to respective types of a plurality of the crops, and is configured or programmed to consult one of the plurality of tables that corresponds to the type of the crop to calculate the after-time outer end position.

9. The assist system according to claim 6, wherein
the estimator is configured or programmed to, in a case that the object is a crop, identify a type of the crop; and
the server includes a plurality of the growth tables corresponding to respective types of a plurality of the crops, and is configured or programmed to consult one of the plurality of growth tables that corresponds to the type of the crop to calculate the after-time outer end position.

10. The assist system according to claim 1, wherein
the second mobile body includes a position detector to detect a position thereof but does not include the detector;
the server includes a route generator configured or programmed to generate a route to be traveled by the second mobile body based on acquired position information of the second mobile body and based on the after-time outer end position calculated by the calculator; and
the second communicator is configured or programmed to transmit the route to be traveled by the second mobile body to the second mobile body.

11. The assist system according to claim 1, wherein
the calculator is configured or programmed to define an off-limits area having a predetermined dimension extending from an outer end position of the object outward based on the object information and the detection time information, and use an outer end position of the off-limits area as the after-time outer end position; and
the second communicator is configured or programmed to transmit the outer end position of the object and the off-limits area to the first mobile body or to the second mobile body.

12. The assist system according to claim 11, wherein the calculator is configured or programmed to calculate the after-time outer end position by changing the predetermined dimension of the off-limits area based on elapsed time information about a time from the detection time to the time-of-use.

13. The assist system according to claim 11, wherein
the server includes an estimator configured or programmed to identify whether the object is a plant and, in a case that the object is a plant, estimate a type and a growth state of the plant; and
the calculator is configured or programmed to calculate the after-time outer end position by changing the predetermined dimension of the off-limits area based on the detection time and a current growth state of the plant.

14. The assist system according to claim 11, wherein
the second mobile body includes a position detector to detect a position thereof but does not include the detector;
the server includes a route generator configured or programmed to generate a route to be traveled by the second mobile body based on acquired position information of the second mobile body and based on the outer end position of the object calculated by the calculator and the off-limits area; and
the second communicator is configured or programmed to transmit the route to be traveled by the second mobile body to the second mobile body.

15. The assist system according to claim 2, wherein
the calculator is configured or programmed to define a fixed off-limits area having a predetermined dimension extending from an outer end position of the object outward, and use an outer end position of the fixed off-limits area as the after-time outer end position; and
the second communicator is configured or programmed to transmit the outer end position of the object and the fixed off-limits area to the first mobile body or to the second mobile body.
